(19) United States
(12) Patent Application Publication
(10) Pub. No.: US 2023/0026235 A1
(43) Pub. Date: Jan. 26, 2023

(54) METHOD AND DEVICE FOR CONTROLLING HOUSEHOLD APPLIANCE

(71) Applicant: SAMSUNG ELECTRONICS CO., LTD., Suwon-si (KR)

(72) Inventor: Kwanho PARK, Suwon-si (KR)

(73) Assignee: SAMSUNG ELECTRONICS CO., LTD., Suwon-si (KR)

(21) Appl. No.: 17/901,450

(22) Filed: Sep. 1, 2022

Related U.S. Application Data
(63) Continuation of application No. PCT/KR2022/010783, filed on Jul. 22, 2022.

(30) Foreign Application Priority Data
Jul. 22, 2021 (KR) 10-2021-0096745

(51) Int. Cl. H04W 76/10; H04L 12/28; H04B 1/69; H04W 48/08; G01S 5/02

(52) U.S. Cl. CPC H04W 76/10; H04L 12/2803; H04B 1/69; H04W 48/08; G01S 5/0284; H04W 84/12

(57) ABSTRACT

A method of controlling a household appliance including receiving a device connection request signal through ultra wideband (UWB) communication from a user terminal, obtaining location information of the user terminal based on the received device connection request signal, establishing a UWB communication channel between the household appliance and the user terminal based on the obtained location information. The method includes receiving network access information to access a network from the user terminal through the established UWB communication channel, and establishing a network connection for the household appliance to access the network based on the received network access information.

### CROSS-REFERENCE TO RELATED APPLICATION

This application is a continuation application, under 35 U.S.C. § 111(a), of international application No. PCT/KR2022/010783, filed on Jul. 22, 2022, which claims priority under 35 U. S. C. § 119 to Korean Patent Application No. 10-2021-0096745 filed on Jul. 22, 2021, the disclosures of which are incorporated herein by reference in their entirety.

### BACKGROUND

### Field

The disclosure relates to a household appliance, a method of controlling the household appliance, and a computer-readable recording medium having recorded thereon a program for executing, on a computer, the method of controlling the household appliance.

### Description of Related Art

With the widespread popularization of Internet of Things (IoT) products, things nearby people are connected to the Internet, and thus, people's lives are becoming better. However, because many IoT products do not have a touch screen like a smartphone, user input is very limited. This restriction poses an obstacle for users to operate IoT products in a network configuration mode. Also, even when an IoT product operates in a network configuration mode, there is a risk that the IoT product may become visible to a neighboring network, and thus, a connection by an unauthorized user to the IoT product may become possible.

### SUMMARY

According to an embodiment of the disclosure, a method of controlling a household appliance includes: receiving a device connection request signal through ultra wideband (UWB) communication from a user terminal; obtaining location information of the user terminal based on the received device connection request signal, establishing a UWB communication channel between the household appliance and the user terminal based on the obtained location information, receiving network access information to access a network from the user terminal through the generated UWB communication channel, and establishing a network connection for the household appliance to access the network based on the received network access information.

The obtaining of the location information of the user terminal may include: measuring an angle at which the device connection request signal is received through a first UWB antenna and a second UWB antenna included in the household appliance, and based on the measured angle, obtaining coordinates representing the location information of the user terminal.

The network access information may include information about an accessible access point (AP), a password with respect to the AP, and a security setting.

The receiving of the network access information to access the network from the user terminal may include receiving access information related to a Wi-Fi network that the user terminal is accessing.

The receiving of the network access information to access the network from the user terminal may include: receiving a result of determining that the user terminal is accessing a mobile communication network, requesting access information related to a local network in which the user terminal is located based on a location of the user terminal, and receiving the access information related to the local network.

The receiving of the network access information to access the network from the user terminal through the established UWB communication channel may further include receiving, from the user terminal, user account identification information for a server connection.

The receiving of the network access information to access the network from the user terminal through the established UWB communication channel may further include receiving attribute information of the household appliance from the user terminal.

The attribute information of the household appliance may include at least one of location information, time information, or language information of the household appliance previously set by a user in the user terminal.

The receiving of the network access information to access the network from the user terminal through the generated UWB communication channel may further include receiving setting information or history information of a same type of household appliance previously used by a user from the user terminal.

According to another embodiment of the disclosure, a household appliance includes at least one ultra wideband (UWB) antenna, a UWB communication module configured to perform short-range wireless communication with a user terminal, a network communication module configured to access a network and wirelessly transmit and receive data, a memory storing one or more instructions, and at least one processor connected to the memory, wherein the at least one processor is configured to execute the one or more instructions to receive a device connection request signal through UWB communication from the user terminal, obtain location information of the user terminal based on the received device connection request signal, establish an UWB communication channel between the household appliance and the user terminal based on the obtained location information, receive network access information to access a network from the user terminal through the generated UWB communication channel, and establish a network connection for the household appliance to access the network based on the received network access information.

According to another embodiment of the disclosure, a computer-readable recording medium having recorded thereon a program for executing, on a computer, the method of controlling a household appliance is provided.

### BRIEF DESCRIPTION OF DRAWINGS

This disclosure may be readily understood by reference to the following detailed description and the accompanying drawings, in which reference numerals refer to structural elements.

FIG. 1 is a diagram illustrating a household appliance control system according to an embodiment of the disclosure.

FIG. 2 is a diagram illustrating a household appliance, a user terminal, and an access point (AP) device according to an embodiment of the disclosure.

FIG. 3 is a diagram illustrating a structure of a user terminal according to an embodiment of the disclosure.

FIG. 4 is a flowchart illustrating a household appliance control method according to an embodiment of the disclosure.

FIG. 5 is a flowchart illustrating a method, performed by a household appliance, of accessing a network according to an embodiment of the disclosure.

FIG. 6 is a diagram illustrating an operation in which a household appliance receives an ultra-wideband (UWB) connection request signal from a user terminal according to an embodiment of the disclosure.

FIG. 7 is a diagram illustrating a location condition of a user terminal according to an embodiment of the disclosure.

FIG. 8 is a diagram illustrating a method of measuring a location of a user terminal based on coordinates according to an embodiment of the disclosure.

FIG. 9 is a flowchart illustrating a method, performed by a user terminal, of transferring Wi-Fi network access information according to an embodiment of the disclosure.

FIG. 10 is a flowchart illustrating a method, performed by a user terminal, of transferring local network access information according to an embodiment of the disclosure.

FIG. 11 is a diagram illustrating an operation in which a household appliance receives Wi-Fi network access information from a user through a device registration graphical user interface (GUI) according to an embodiment of the disclosure.

FIG. 12A is a diagram illustrating an operation in which a household appliance receives attribute information of the household appliance from a user through a device registration GUI according to an embodiment of the disclosure.

FIG. 12B is a diagram illustrating an operation in which a household appliance receives, through a device registration GUI, setting information or history information of the same type of a household appliance previously used from a user according to an embodiment of the disclosure.

FIG. 13 is a flowchart illustrating a method of registering a household appliance with a server according to an embodiment of the disclosure.

FIG. 14 is a diagram illustrating an operation of registering a household appliance with a server according to an embodiment of the disclosure.

FIG. 15 is a block diagram illustrating a structure of a household appliance according to an embodiment of the disclosure.

FIG. 16 is a block diagram illustrating a user terminal in a network environment according to various embodiments of the disclosure.

### DETAILED DESCRIPTION OF EXEMPLARY EMBODIMENTS

Throughout the disclosure, the expression “at least one of a, b or c” indicates only a, only b, only c, both a and b, both a and c, both b and c, all of a, b, and c, or variations thereof.

The terms used in the specification are briefly described and the disclosure is described in detail.

The terms used in the disclosure have been selected from currently widely used general terms in consideration of the functions in the disclosure. However, the terms may vary according to the intention of one of ordinary skill in the art, case precedents, and the advent of new technologies. Furthermore, for special cases, meanings of the terms selected by the applicant are described in detail in the description section. Accordingly, the terms used in the disclosure are defined based on their meanings in relation to the contents discussed throughout the specification, not by their simple meanings.

When a part may “include” a certain constituent element, unless specified otherwise, it may not be construed to exclude another constituent element but may be construed to further include other constituent elements. Furthermore, terms such as “. . . portion,” “ . . . unit,” “ . . . module,” and “ . . . block” stated in the specification may signify a unit to process at least one function or operation and the unit may be embodied by hardware, software, or a combination of hardware and software.

Hereinafter, the disclosure will now be described more fully with reference to the accompanying drawings for one of ordinary skill in the art to be able to perform the embodiments of the disclosure without any difficulty. However, the disclosure is not limited thereto and it will be understood that various changes in form and details may be made in the embodiments of the disclosure without departing from the spirit and scope of the following claims. In the drawings, a part that is not related to a description is omitted to clearly describe the disclosure and, throughout the specification, similar parts are referenced with similar reference numerals.

The disclosure provides a household appliance for, in a process of connecting the household appliance to a network in a new product state before a network access, improving difficulties that a user of a smart household appliance experiences for the network access and improving security vulnerabilities that may occur during a network connection process, and a method of controlling the household appliance.

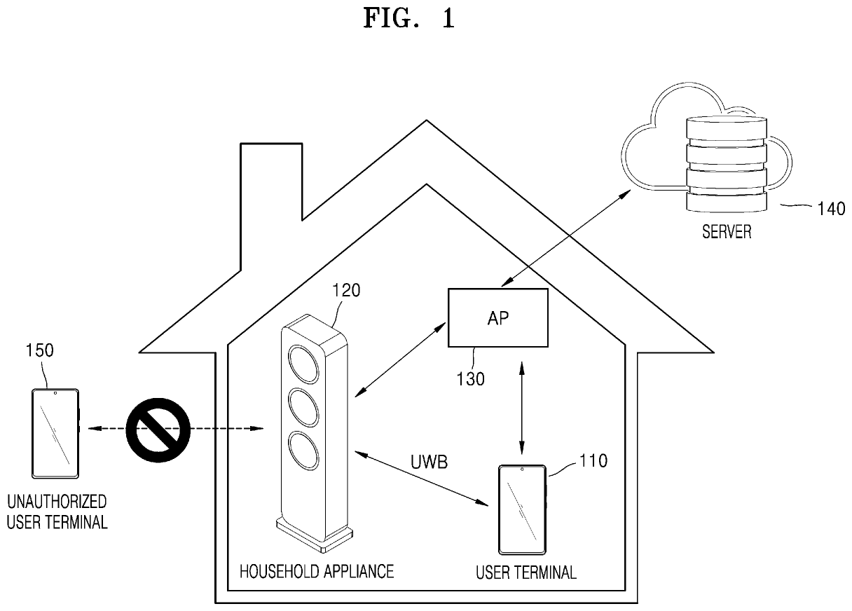

FIG. 1 is a diagram illustrating a household appliance control system according to an embodiment of the disclosure.

Referring to FIG. 1, a system for controlling a household appliance (hereinafter, referred to as the household appliance control system) according to an embodiment of the disclosure may include a user terminal 110, a household appliance 120, an access point (AP) device 130, and a server 140. However, all illustrated components are not dispensable components. The household appliance control system may be implemented by more components than the illustrated components, and the household appliance control system may be implemented by fewer components than those components. The household appliance 120 according to an embodiment of the disclosure may include an ultra-wideband (UWB) communication module, and may communicate with the user terminal 110 through a generated UWB communication channel.

The household appliance 120 according to an embodiment of the disclosure may perform Wi-Fi communication with the AP device 130, and may access a network through the AP device 130. In addition, the household appliance 120 according to an embodiment of the disclosure may access the server 140 by accessing the network through the AP device 130.

The household appliance 120 according to an embodiment of the disclosure may access the network through the AP device 130. The household appliance 120 may provide various functions by accessing the network through the AP device 130. The household appliance 120 according to an embodiment of the disclosure may perform network communication with the user terminal 110 connected to the AP device 130. The household appliance 120 may provide various functions through an application executed in the user terminal 110. The application executed in the user terminal 110 may provide functions such as monitoring, control, automation, and voice assistant of the household appliance 120.

The household appliance 120 according to an embodiment of the disclosure may access the server 140 by accessing the network through the AP device 130. The household appliance 120 according to an embodiment of the disclosure may access the server 140 and be registered with the server 140. The household appliance 120 may be registered with the server 140 and connected to a certain account. The household appliance 120 may be monitored and controlled by the user terminal 110 logged in the connected account while being managed as a device of the certain account. An application executed in the user terminal 110 according to an embodiment of the disclosure may operate in conjunction with the server 140, and may provide functions such as monitoring, control, automation, and voice assistant of the household appliance 120.

In order to provide such an application function, the household appliance 120 needs to access the network through the AP device 130 or access the server 140 to establish communication with the user terminal 110. However after the household appliance 120 is released from the factory, in a new product state before the household appliance 120 accesses the network through the AP device 130 or is registered with the server 140, the household appliance 120 may not provide an application function and various function provided by the server 140. Such a new product state is called an out of box (OOB) state.

As described above, the new product state means a state before the household appliance 120 accesses the network or is registered with the server 140. In order for the household appliance 120 in the new product state to access the network through the AP device 130 or access the server 140, the household appliance 120 needs to receive information (an SSID, an ID, a password, an authentication method, an encryption method, an authentication key, etc. of the AP device 130) required for network access from the user terminal 110 or user account identification information for connection to the server 140.

In this regard, a general household appliance needs to be switched to a network connection mode in order to receive information necessary for network access or user account identification information for connection to the server 140 from the user terminal 110. In order for the general household appliance to switch to the network connection mode, it is necessary for the user to input a button of the household appliance or a button of a remote controller operating the appliance. For example, when the household appliance is an air purifier, the user may switch the air purifier to the network connection mode by long pressing an air volume button of the air purifier or long pressing a reservation button of a remote controller of the air purifier. However, respective household appliances have different types of buttons and different time of button inputs so as to be switched to the network connection mode. Also, because the general household appliance has limited means for expressing a current state by itself, the general household appliance may be difficult to determine whether the current state is the network connection mode.

In addition, when the general household appliance is switched to the network connection mode, the general household appliance may be exposed to the surrounding network so that a search and a connection attempt are possible through the user terminal 110. When an unauthorized user terminal 150 accesses the household appliance switched to the network connection mode for the purpose of hacking and provides AP information (network access information) of a wrong path, there is a possibility that the household appliance may be connected to a network that is not intended by a genuine user so that inside information may be stolen.

Therefore, according to an embodiment of the disclosure, in order for the household appliance 120 to receive information necessary for the network connection, a technology of requiring no button operation of the household appliance 120, and generating a communication channel by a one-touch input of the user terminal 110 is proposed. In addition, in order to improve security vulnerabilities, an UWB technology for generating a communication channel only when a user terminal is proximate to a household appliance is proposed. There is a difference between a WiFi or BLE technology, which is a general communication method, incapable of determining an accurate location of a user terminal to be accessed, and the UWB technology capable of determining proximity of the user terminal and the accurate location.

The household appliance 120 according to an embodiment of the disclosure may receive a device connection request signal for generating an UWB communication channel from the user terminal 110. The user terminal 110 may execute an application related to the household appliance 120, and receives a user input to send the device connection request signal for generating the UWB communication channel between the user terminal 110 and the household appliance 120.

The device connection request signal according to an embodiment of the disclosure may be sent from an UWB antenna embedded in the user terminal 110, and the sent device connection request signal may be received by an UWB antenna embedded in the household appliance 120.

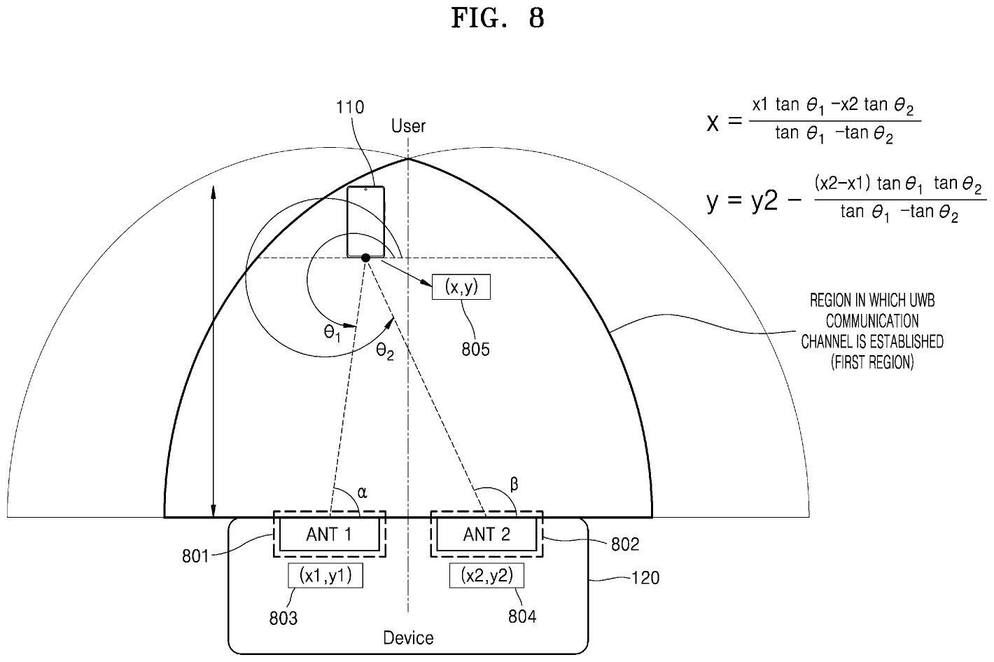

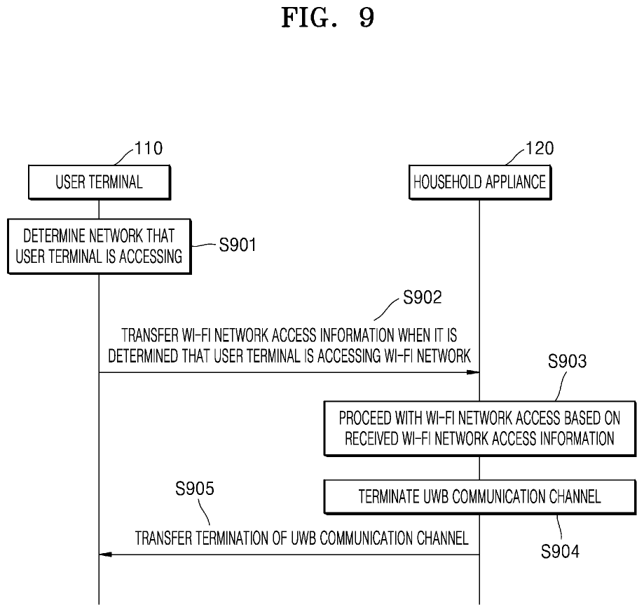

The household appliance 120 according to an embodiment of the disclosure may obtain location information of the user terminal 110 based on the received device connection request signal, and generate the UWB communication channel only when it is determined that the user terminal 110 is in a location proximity to the household appliance 120. Accordingly, the user terminal 150 which is determined not to be present in a region for generating a communication channel because the user terminal 150 is not proximate to the household appliance 120 or is present in a region blocked by a wall may be determined as an unauthorized terminal and may not generate an UWB communication channel. A detailed method, performed by the household appliance 120, of obtaining the location information of the user terminal 110 based on the device connection request signal will be described with reference to FIGS. 8 and 9.

The household appliance 120 according to an embodiment of the disclosure may generate the UWB communication channel between the household appliance 120 and the user terminal 110, and may receive the information necessary for the network access or the user account identification information for connection to the server 140 through the generated UWB communication channel.

The household appliance 120 according to an embodiment of the disclosure may access the network using the information (the SSID, the ID, the password, the authentication method, the encryption method, the authentication key, etc. of the AP device 130) required for the network access received through the generated UWB communication channel. The household appliance 120 according to an embodiment of the disclosure may access the server 140 using the user account identification information for connection to the server 140 received through the generated UWB communication channel. The household appliance 120 may access (e.g., log-in or sign-in) the server 140 using the user account identification information for connection to the server 140, and complete an operation of registering the household appliance 120 with the server 140. The household appliance 120 may be connected to a specific account of the server 140.

When the household appliance 120 according to an embodiment of the disclosure accesses the network or accesses and is registered with the server 140, the household appliance 120 may terminate the UWB communication channel generated between the household appliance 120 and the user terminal 110. At this time, the household appliance 120 may transfer the termination of the UWB communication channel to the user terminal 110, and when the user terminal 110 receives the termination of the UWB communication channel, the UWB communication channel generated between the household appliance 120 and the user terminal 110 may be terminated.

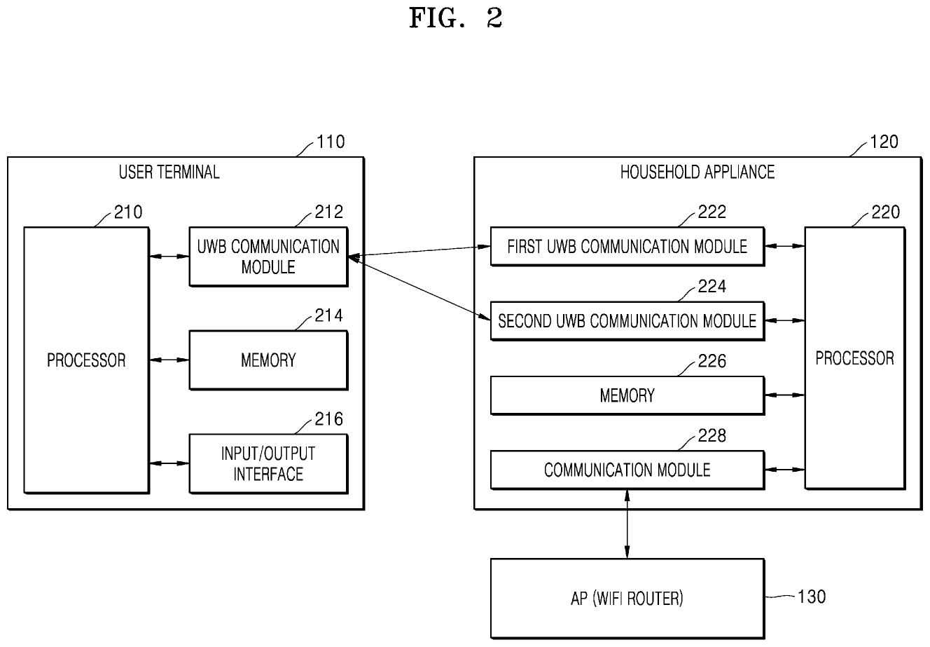

FIG. 2 is a diagram illustrating the household appliance 120, the user terminal 110, and the AP device 130 according to an embodiment of the disclosure.

According to an embodiment of the disclosure, the household appliance 120 may include a processor 220, a first UWB communication module 222, a second UWB communication module 224, a memory 226, and a communication module 228.

The household appliance 120 is an electronic device that performs a certain function. The household appliance 120 is disposed at a certain location in the house. The household appliance 120 may include, for example, a refrigerator, a kimchi refrigerator, a washing machine, a TV, an air conditioner, an air purifier, a cleaning robot, a vacuum cleaner, a clothes manager, an oven, a microwave oven, an induction device, an audio output device, or a smart home hub device.

The household appliance 120 includes a certain household appliance function module to perform its original function. For example, the household appliance function module may include a cooler, a container, a door, a temperature sensor, a door opening/closing sensor, a light, etc. which are provided in the refrigerator. As another example, the household appliance function module may include a washing tub, a motor, a door, a door opening/closing sensor, a water supply unit, a drain unit, etc. which are provided in the washing machine. As another example, the household appliance function module may include a vacuum suction assembly, a dust container, a brush, etc. which are provided in the cleaner.

The processor 220 controls the overall operation of the household appliance 120. The processor 220 may be implemented as one or more processors. The processor 220 may execute an instruction or a command stored in the memory 226 to perform a certain operation. In addition, the processor 220 controls operations of components included in the household appliance 120.

Each of the first UWB communication module 222 and the second UWB communication module 224 may include one or more components that enable communication between the user terminal 110 and the household appliance 120.

According to an embodiment of the disclosure, the first UWB communication module 222 and the second UWB communication module 224 may include one or more components that enable UWB communication. UWB communication is ultra-wideband communication, and may refer to wireless communication that transfers a large amount of information with low power over a very wide band compared to the existing spectrum. Unlike the BLE communication technology capable of approximately inferring whether a user terminal is present in a certain space, the UWB communication technology may accurately determine whether the user terminal is present in a proximate region. In addition, the UWB communication technology may determine that a user terminal is within a proximity distance and a certain angle from a household appliance, thereby accurately determining that the user terminal is in an allowable location, and thus access from an unauthorized user may be blocked.

The first UWB communication module 222 according to an embodiment of the disclosure may include a first UWB antenna, and the second UWB communication module 224 may include a second UWB antenna. The first UWB antenna and the second UWB antenna may simultaneously receive a device connection request signal transferred from the user terminal 110, and determine an accurate location of the user terminal 110 based on the intensity of the received signal.

The first UWB communication module 222 and the second UWB communication module 224 according to an embodiment of the disclosure may establish UWB communication with the user terminal 110 under the control by the processor 220. The first UWB communication module 222 and the second UWB communication module 224 may transmit control signals and data to the user terminal 110 or receive control signals and data from the user terminal 110.

The memory 226 stores various information, data, instructions programs, etc. necessary for the operation of the household appliance 120. The memory 226 may include at least one of volatile memory or non-volatile memory, or a combination thereof. The memory 226 may include at least one type of storage medium among a flash memory type, a hard disk type, a multimedia card micro type, a card type memory (e.g., SD or XD memory, etc.), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, or optical disk. Also, the memory 226 may correspond to a web storage or a cloud server that performs a storage function on the Internet.

The communication module 228 may include one or more components that enable communication between the household appliance 120 and the AP device 130.

According to an embodiment of the disclosure, the communication module 228 may communicate with the AP device 130 and communicate with the server 140 through a long-range communication network connected to the AP device 130.

The communication module 228 according to an embodiment of the disclosure may include a wireless communication module (e.g., a cellular communication module, a short-range wireless communication module, a global navigation satellite system (GNSS) communication module) and a wired communication module (e.g., a local area (LAN) communication module or a power line communication module). In addition, the communication module 228 may include a short-range wireless communication interface or a long-range communication interface, but is not limited thereto.

The short-range wireless communication interface may include a Bluetooth communication interface, a Bluetooth Low Energy (BLE) communication interface, a Near Field Communication (NFC) interface, a wireless LAN (WLAN) (Wi-Fi) communication interface, a Zigbee communication interface, an infrared (IrDA) communication interface, a Wi-Fi Direct (WFD) communication interface, an UWB communication interface, an Ant+ communication interface, a microwave (uWave) communication interface, etc., but is not limited thereto.

The long-range communication interface may communicate with an external device through, for example, a legacy cellular network, a 5G network, a next-generation communication network, the Internet, or a computer network (e.g., LAN or WAN). The mobile communication interface transmits/receives a wireless signal to and from at least one of a base station, an external terminal, or a server on a mobile communication network. Here, the wireless signal may include various types of data according to transmission/reception of a voice signal, a video call signal, or a text/multimedia message.

The household appliance 120 may be connected to an external network through the AP device 130. At this time, the external network connected to the household appliance 120 may use various communication links such as a ZigBee communication network, a Wi-Fi communication network, a Bluetooth communication network, a mobile communication network, a local area network (LAN), a wide area network (WAN), or a point-to-point telephone line connection. Also, the household appliance 120 may access the server 140 through the AP device 130, and may be registered in a certain account registered with the server 140.

The user terminal 110 may include a processor 210, an UWB communication module 212, a user terminal memory 214, and an input/output interface 216.

The processor 210 controls the overall operation of the user terminal 110. The processor 210 may be implemented as one or more processors. The processor 210 may execute an instruction or a command stored in the user terminal memory 214 to perform a certain operation.

The UWB communication module 212 may include one or more components that enable communication between the user terminal 110 and the household appliance 120.

According to an embodiment of the disclosure, the UWB communication module 212 may include one or more components that enable UWB communication. The UWB communication module 212 according to an embodiment of the disclosure may include an UWB antenna. When the user terminal 110 receives a device connection request signal for generating an UWB communication channel through a device registration graphical user interface (GUI), the user terminal 110 may transfer the received device connection request signal to the household appliance 120 using the UWB antenna. According to the intensity of the device connection request signal transferred to the household appliance 120 using the UWB antenna, the household appliance 120 may determine whether the user terminal 110 is proximate to the household appliance 120. When the household appliance 120 determines that the user terminal 110 is proximate to the household appliance 120, the household appliance 120 may generate an UWB communication channel between the household appliance 120 and the user terminal 110.

The UWB communication module 212 may establish communication with the household appliance 120 under the control by the processor 210, and the UWB communication module 212 transmits a control signal and data to the household appliance 120, or receives a control signal and data from the device 120.

The memory 214 stores various information, data, instructions, programs, etc. necessary for the operation of the user terminal 110. The memory 214 may include at least one of volatile memory or non-volatile memory, or a combination thereof. The memory 214 may include at least one type of storage medium among a flash memory type, a hard disk type, a multimedia card micro type, a card type memory (e.g., SD or XD memory, etc.), RAM, SRAM, ROM, EEPROM, PROM, magnetic memory, magnetic disk, or optical disk. Also, the memory 214 may correspond to a web storage or a cloud server that performs a storage function on the Internet.

The memory 214 stores an application for registering or controlling the household appliance 120. The processor 210 registers or controls the household appliance 120 by executing an application. The application provides functions such as registration, monitoring, control, automation, and voice assistant of the household appliance 120. The memory 214 stores the application in advance, or receives and stores the application from a cloud server.

The input/output interface 216 may receive a command or data to be used for a component (e.g., the processor 210) of the user terminal 110 from the outside (e.g., a user) of the user terminal 110. The input/output interface 216 may include, for example, a touch screen, a touch pad, keys, a microphone, a mouse, a keyboard, or a digital pen (e.g., a stylus pen). In addition, the input/output interface 216 includes, for example, a display, a speaker, a vibration device, etc.

The input/output interface 216 provides a graphical user interface (GUI) related to an application and receives a user input entered through the GUI. The input/output interface 216 has abundant resources compared to the input/output interface of the household appliance 120. For example, the input/output interface 216 includes the touch screen, the keys, the microphone, the speaker, the vibration device, etc., whereas the household appliance 120 may have only a limited number of keys and a small display. According to embodiments of the disclosure, a control input for controlling the household appliance 120 is received by using the user terminal 110 having abundant input/output resources compared to the household appliance 120.

The AP device 130 is a wireless access device, and may be connected to the communication module 228 mounted on the household appliance 120 to connect the household appliance 120 to an external network. Also, the AP device 130 may connect the household appliance 120 and the server 140 through the long-range communication network connected to the AP device 130.

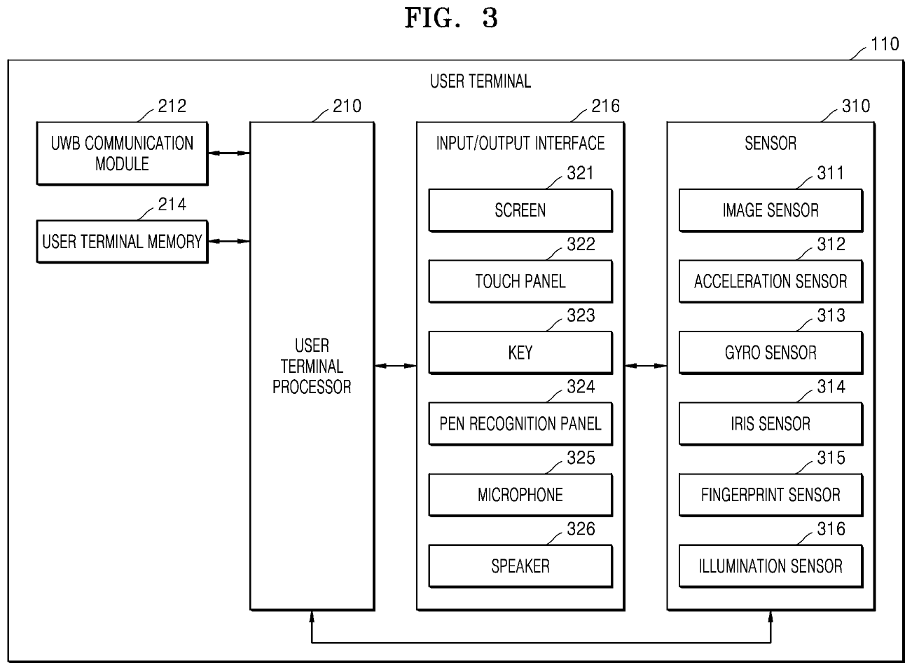

FIG. 3 is a diagram illustrating a structure of the user terminal 110 according to an embodiment of the disclosure.

The user terminal 110 according to an embodiment of the disclosure includes the processor 210, the UWB communication module 212, the user terminal memory (memory) 214, the input/output interface 216, and a sensor 310. The user terminal 110 may include abundant input/output resources and the sensor 310 compared to the household appliance 120. For example, the input/output interface 216 may include a touch screen 321, a touch panel 322, a key 323, a pen recognition panel 324, a microphone 325, a speaker 326, etc. The sensor 310 may include an image sensor 311, an acceleration sensor 312, a gyro sensor 313, an iris sensor 314, a fingerprint sensor 315, an illumination sensor 316, etc.

The user terminal 110 may control the household appliance 120 by using the input/output interface 216 and the sensor 310. The user terminal 110 executes an application that controls the household appliance 100, and establishes a communication connection with the household appliance 120. The user terminal 110 receives various types of control signals through the application. The control signal may be input through the touch screen 321, the touch panel 322, the key 323, the pen recognition panel 324, the microphone 325, etc. In addition, the user terminal 110 provides various types of output through the application. The output of the application may be an output through the touch screen 321, the speaker 326, etc.

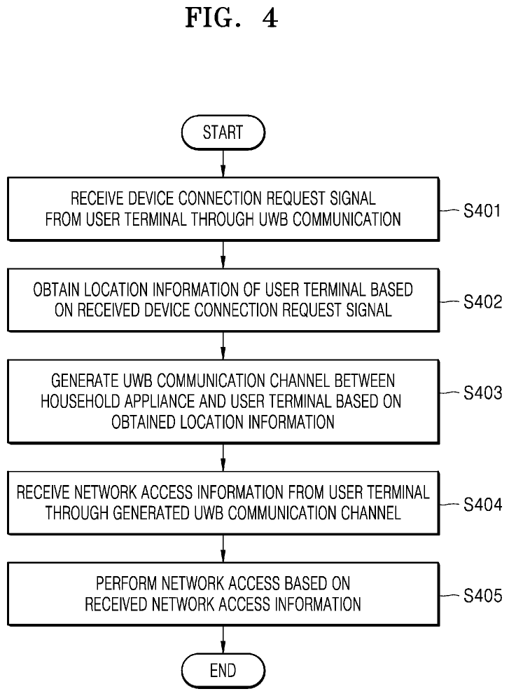

FIG. 4 is a flowchart illustrating a household appliance control method according to an embodiment of the disclosure.

Each operation of the household appliance control method according to an embodiment of the disclosure may be performed by various types of electronic devices including a processor and a communication module and communicating with the user terminal 110 and the server 140. In the disclosure, an embodiment in which the household appliance 120 according to embodiments of the disclosure performs the household appliance control method will be mainly described. Therefore, the embodiments described with respect to the household appliance 120 are applicable to the embodiments of the household appliance control method, and, on the contrary, the embodiments described with respect to the household appliance control method is applicable to the embodiments of the household appliance 120. The household appliance control method according to the disclosed embodiments of the disclosure is performed by the household appliance 120 disclosed in the disclosure but is not limited thereto, and may be performed by various types of electronic devices.

In operation S401, the household appliance 120 according to an embodiment of the disclosure may receive a device connection request signal from the user terminal 110 through UWB communication.

The user terminal 110 according to an embodiment of the disclosure may execute an application and receive the device connection request signal from a user through a device registration GUI. The user terminal 110 may transfer the received device connection request signal from the user terminal 110 to the household appliance 120 through UWB communication. For example, the user terminal 110 may transfer the device connection request signal to the household appliance 120 by receiving an input of touching a button indicating a device connection request through the device registration GUI.

Here, the device connection request may be a request for generating a communication channel between the user terminal 110 and the household appliance 120 in order for the household appliance 120 to transfer network access information to access a network.

The device connection request signal according to an embodiment of the disclosure may be sent through an UWB antenna embedded in the user terminal 110, and the sent device connection request signal may be received by a first UWB antenna and a second UWB antenna embedded in the household appliance 120.

In operation S402, the household appliance 120 may obtain location information of the user terminal 110 based on the received device connection request signal.

According to an embodiment of the disclosure, the first UWB antenna and the second UWB antenna embedded in the household appliance 120 may receive the device connection request signal sent through an UWB antenna of the user terminal 110. At this time, the first UWB antenna and the second UWB antenna may obtain the location information of the user terminal 110 by measuring an angle at which the device connection request signal is received. For example, the first UWB antenna and the second UWB antenna may obtain the location information of the user terminal 110 by utilizing an angle of arrival (AOA). At this time, the location information of the user terminal 110 may be expressed as coordinates. A process of obtaining the location information of the user terminal 110 will be described in detail with reference to FIGS. 8 and 9.

In operation S403, the household appliance 120 may generate an UWB communication channel between the household appliance 120 and the user terminal 110 based on the obtained location information.

According to an embodiment of the disclosure, the household appliance 120 may obtain the location information of the user terminal 110 as coordinates, by measuring the angle at which the device connection request signal is received. The household appliance 120 may determine whether the coordinates that are the location information of the user terminal 110 are within a valid region in which the user may make a connection request from the household appliance 120, and, when it is determined that the coordinates are within the valid region, generate the UWB communication channel.

At this time, the valid region in which the user may make a connection request from the household appliance 120 may be a certain region in front of the household appliance 120. Accordingly, a user terminal that is located in the front of the household appliance 120 but is determined not to be located in a certain region or a user terminal that is determined to be located in the rear of the household appliance 120 may be treated as an unauthorized user terminal. In addition, no UWB communication channel may be generated between the unauthorized user terminal and the household appliance 120. The valid region in which the user may make a connection request from the household appliance 120 will be described in detail with reference to FIGS. 8 and 9.

In operation S404, the household appliance 120 may receive network access information from the user terminal 110 through the generated UWB communication channel.

According to an embodiment of the disclosure, the household appliance 120 may receive information necessary for network access from the user terminal 110 through the generated UWB communication channel. For example, the household appliance 120 may receive an SS ID, an ID, a password, an authentication method, an encryption method, an authentication key, etc. of the AP device 130 from the user terminal 110 through the UWB communication channel.

According to an embodiment of the disclosure, the user terminal 110 may determine a network that the user terminal 110 is accessing. When it is determined that the user terminal 110 is accessing a Wi-Fi network, the user terminal 110 may directly transmit access information of the Wi-Fi network that the user terminal 110 is accessing, to the household appliance 120. In addition, the user terminal 110 may receive a user input to select one of Wi-Fi networks that the user terminal 110 is accessible through the device registration GUI, and transmit the Wi-Fi network access information selected by the user to the household appliance 120.

According to an embodiment of the disclosure, when it is determined that the user terminal 110 is accessing a mobile communication network, the user terminal 110 may transfer a result that the user terminal 110 is currently accessing the mobile communication network, to the household appliance 120. The household appliance 120 that receives the result that the user terminal 110 is accessing the mobile communication network may request the user terminal 110 for access information related to a local network of a location of the user terminal 110 based on the location of the user terminal 110. The user terminal 110 may transmit the access information related to the local network based on the location of the user terminal 110 to the household appliance 120 according to a request.

According to an embodiment of the disclosure, the user terminal 110 may transmit user account identification information for connection to the server 140 to the household appliance 120. Here, the user account identification information for connection to the server 140 may include server access account ID information, server access path information, server account token information, etc.

In operation S405, the household appliance 120 may perform network access based on the received network access information.

According to an embodiment of the disclosure, the household appliance 120 may establish a connection between the AP device 130 and the household appliance 120 based on the received network access information to perform an operation of accessing the network. The household appliance 120 may receive the SSID, the ID, the password, etc. of the AP device 130 from the user terminal 110, and may be connected to the AP device 130 based on the received information to access the network.

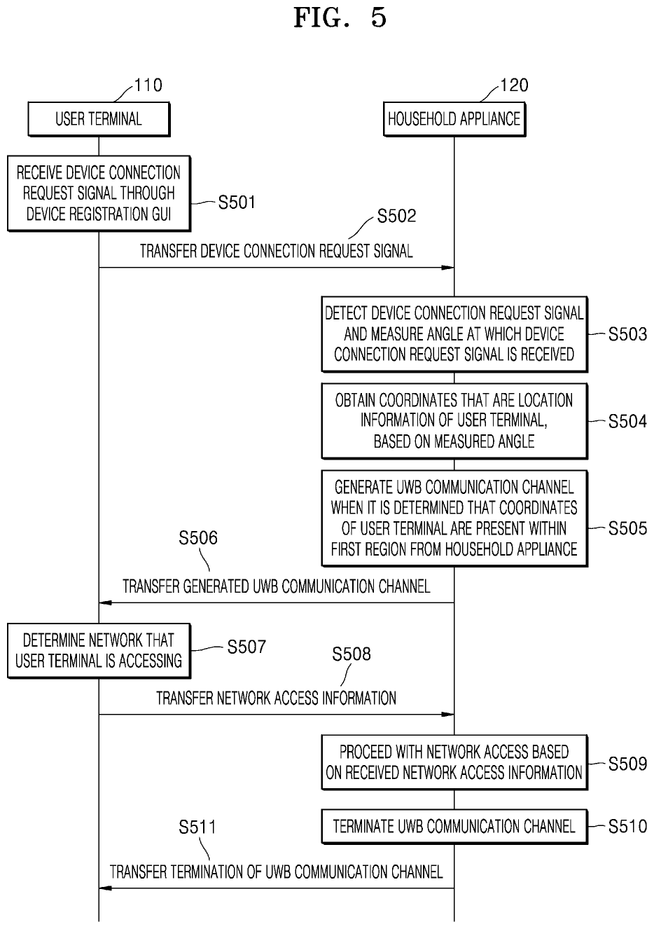

An operation in which the household appliance 120 accesses the network based on the network access information received through the generated UWB communication channel will be described in detail with reference to FIG. 5.

FIG. 5 is a flowchart illustrating a method, performed by the household appliance 120, of accessing a network according to an embodiment of the disclosure.

In operation S501, the user terminal 110 according to an embodiment of the disclosure may receive a device connection request signal through a device registration GUI.

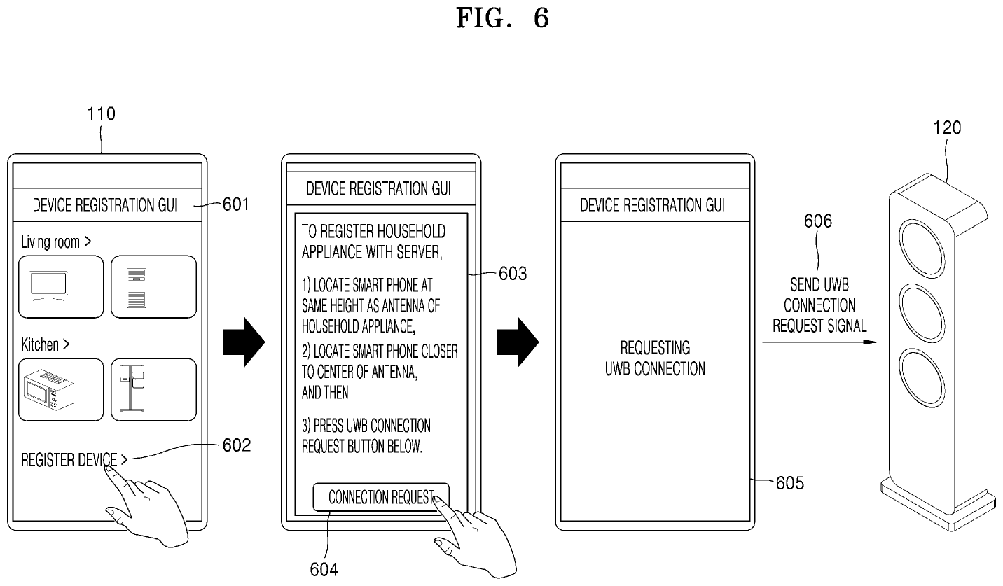

The user terminal 110 according to an embodiment of the disclosure may execute an application related to the control by the household appliance 120 and receive a user input related to the device connection request signal from a user through the device registration GUI. An operation in which the user terminal 110 receives the user input related to the device connection request signal through the device registration GUI will be described in detail with reference to FIG. 6.

In operation S502, the user terminal 110 according to an embodiment of the disclosure may transfer the device registration request signal to the household appliance 120.

When receiving the user input related to the device registration request from a user, the user terminal 110 according to an embodiment of the disclosure may send the device registration request signal through an UWB antenna embedded in the user terminal 110. The sent device connection request signal may be received by a first UWB antenna and a second UWB antenna embedded in the household appliance 120.

In operation S503, the household appliance 120 according to an embodiment of the disclosure may detect the device connection request signal and measure an angle at which the device connection request signal is received.

The household appliance 120 according to an embodiment of the disclosure may detect the device connection request signal sent through the UWB antenna of the user terminal 110, by using the first UWB antenna and the second UWB antenna embedded in the household appliance 120. The household appliance 120 according to an embodiment of the disclosure may measure the angle at which the device connection request signal is received, by using the first UWB antenna and the second UWB antenna. The first UWB antenna and the second UWB antenna may measure a first angle and a second angle at which the device connection request signal is received, respectively, by using an AoA-based positioning method. Here, the first angle may mean an incident angle moving along a straight line from the UWB antenna of the user terminal 110 to the first UWB antenna of the household appliance 120. In addition, the second angle may mean an incident angle moving along a straight line from the UWB antenna of the user terminal 110 to the second UWB antenna of the household appliance 120.

In operation S504, the household appliance 120 according to an embodiment of the disclosure may obtain coordinates that are location information of the user terminal 110, based on the measured angle.

The household appliance 120 according to an embodiment of the disclosure may measure the first angle and the second angle at which the device connection request signal is received, by using the first UWB antenna and the second UWB antenna embedded in the household appliance 120. The household appliance 120 according to an embodiment of the disclosure may obtain two-dimensional coordinates of the user terminal 110 defined on the same plane as the first UWB antenna and the second UWB antenna, by using the measured first angle and second angle.

In operation S505, when it is determined that the coordinates of the user terminal 110 are within a first region from the household appliance 120, the household appliance 120 according to an embodiment of the disclosure may generate an UWB communication channel between the household appliance 120 and the user terminal 110.

The household appliance 120 according to an embodiment of the disclosure may determine whether the two-dimensional coordinates of the user terminal 110 defined on the same plane as the first UWB antenna and the second UWB antenna are within the first region which is a valid region. In this case, the first region which is the valid region may mean a region in which a user may make a connection request from the household appliance 120. Here, the user terminal 110 determined to be present within the first region which is the valid region may be determined to be by an authorized user, and a user terminal determined to exist outside the first region which is the valid region may be determined to be by an unauthorized user.

The first region according to an embodiment of the disclosure may correspond to a certain region of a front surface of the household appliance 120. Here, the certain region of the front surface of the household appliance 120 may mean a region in which a semicircular range formed with respect to the first UWB antenna and a semicircular range formed with respect to the second UWB antenna overlap. As another example, the first region may be defined as a region having a certain radius from the center of a certain reference point on the front of the household appliance 120. The certain reference point may be, for example, a point between the first UWB antenna and the second UWB antenna.

When it is determined that the two-dimensional coordinates of the user terminal 110 are within the first region, the household appliance 120 according to an embodiment of the disclosure may generate the UWB communication between the household appliance 120 and the user terminal 110.

In operation S506, the household appliance 120 according to an embodiment of the disclosure may transfer the generated UWB communication channel to the user terminal 110.

In operation S507, the user terminal 110 according to an embodiment of the disclosure may determine a network that the user terminal 110 is accessing.

According to an embodiment of the disclosure, the user terminal 110 may determine whether the user terminal 110 is accessing a Wi-Fi network or a mobile communication network.

In operation S508, the user terminal 110 according to an embodiment of the disclosure may transfer network access information to the household appliance 120.

According to an embodiment of the disclosure, when it is determined that the user terminal 110 is accessing the Wi-Fi network, the user terminal 110 may directly transmit access information of the Wi-Fi network that the household appliance 120 is accessing. Here, the access information of the Wi-Fi network that the household appliance 120 is accessing may include an SSID, an ID, password, an authentication method, an encryption method, an authentication key, etc. of the AP device 130 corresponding to a Wi-Fi router.

According to an embodiment of the disclosure, when it is determined that the user terminal 110 is accessing the mobile communication network, the user terminal 110 may transfer access information related to a local network based on a location of the user terminal 110 to the household appliance 120.

In operation S509, the household appliance 120 according to an embodiment of the disclosure may proceed with network access based on the received network access information.

According to an embodiment of the disclosure, when the household appliance 120 receives the Wi-Fi network access information or the access information related to the local network from the user terminal 110, the household appliance 120 may establish a connection with the AP device 130, based on the received Wi-Fi network access information or access information related to the local network. For example, the Wi-Fi network access information may include the SSID, the ID, the password, etc. of the AP device 130, and the household appliance 120 may establish a connection with the AP device 130 using the ID and password of the AP device 130 included in the Wi-Fi network access information. According to an embodiment of the disclosure, the household appliance 120 may establish a connection with the AP device 130 and perform an operation of accessing the network.

In operation S510, the household appliance 120 according to an embodiment of the disclosure may terminate the UWB communication channel, and in operation S511, the household appliance 120 may transfer termination of the UWB communication channel to the user terminal 110

According to an embodiment of the disclosure, when the household appliance 120 completely accesses the network and it is determined that the household appliance 120 has no further information to receive from the user terminal 110, the household appliance 120 may terminate the UWB communication channel generated between the household appliance 120 and the user terminal 110. According to an embodiment of the disclosure, the household appliance 120 may transfer the termination of the UWB communication channel to the user terminal 110, and when the user terminal 110 receives the termination of the UWB communication channel, the UWB communication channel generated between the household appliance 120 and the user terminal 110 may be terminated.

FIG. 6 is a diagram illustrating an operation in which the household appliance 12 receives an UWB connection request signal from the user terminal 110 according to an embodiment of the disclosure.

In FIG. 6, a case in which a user sets connection request signal through a device registration GUI 601 of the user terminal 110 so that an air conditioner corresponding to the household appliance 120 may access a network will be described as an example.

Referring to FIG. 6, the device registration GUI 601 may include a list of a plurality of household appliances and a device registration icon 602 for registering the new household appliance 120.

The list of the plurality of household appliances may be a list of household appliances that are completely connected to the network by receiving network access information or are registered with a server. The list of the plurality of household appliances may include names of household appliances, icon images of household appliances, etc. In addition, the plurality of household appliances may be classified according to locations in which the household appliances are located and displayed on a screen of the device registration GUI 601. For example, a TV located in a living room may be displayed in a living room list, and a refrigerator located in a kitchen may be displayed in a kitchen list. The user may check whether a household appliance located in the house is connected to the network, by checking the household appliance displayed on the list of the plurality of household appliances.

The device registration icon 602 may be an icon to transfer information about network access with respect to the household appliance 120 before accessing the network. For example, in order to connect the air conditioner which is the household appliance 120 to the network in a new product state before accessing the network after being released from the factory, the user may touch the device registration icon 602 near the air conditioner.

According to an embodiment of the disclosure, when the user terminal 110 receives a user input to touch the device registration request 602, the user terminal 110 may display a guide 603 including conditions with respect to a location of the user terminal 110 that enables an effective transfer of network access information.

According to an embodiment of the disclosure, the network access information is transferred through an UWB communication channel generated between the user terminal 110 and the household appliance 120. In order to generate the UWB communication channel, a condition is required for the user terminal 110 that needs to be proximate to the household appliance 120. That is, the UWB communication channel may be generated only when the location of the user terminal 110 with respect to the household appliance 120 is within a first region that is a valid region. The location of the user terminal 110 may be obtained as two-dimensional coordinates defined on the same plane as those of a first UWB antenna and a second UWB antenna embedded in the household appliance 120, and thus a condition (a first condition) is required for the user terminal 110 that needs to be located at the same height as those of the first UWB antenna and the second UWB antenna.

The first region that is the valid region according to an embodiment of the disclosure may correspond to a certain region of the front of the household appliance 120. Here, the certain region of the front surface of the household appliance 120 may mean a region in which a semicircular range formed with respect to the first UWB antenna and a semicircular range formed with respect to the second UWB antenna overlap. When the user terminal 110 is located at a proximate distance from the center of the first UWB antenna and the second UWB antenna, a probability that the user terminal 110 is located in the first region that is the valid region increases. Accordingly, the user terminal 110 may display on the guide 603 a condition (a second condition) that the user terminal 110 needs to be located close to the center of the two antennas.

The user may locate the user terminal 110 so that the location of the user terminal 110 may satisfy the first and second conditions, and then touch an UWB connection request icon 604. When the user terminal 110 receives a user input to touch the UWB connection request icon 604, the user terminal 110 may display a phrase 605 “requesting UWB connection” on a screen of the device registration GUI 601. The user terminal 110 may display the phrase 605 “requesting UWB connection” and simultaneously send 606 an UWB connection request signal which is a device connection request signal to the household appliance 120. According to an embodiment of the disclosure, the user terminal 110 may send the UWB connection request signal which is the device registration request signal through an embedded UWB antenna. The sent UWB connection request signal which is the device connection request signal may be received by the first UWB antenna and the second UWB antenna embedded in the household appliance 120.

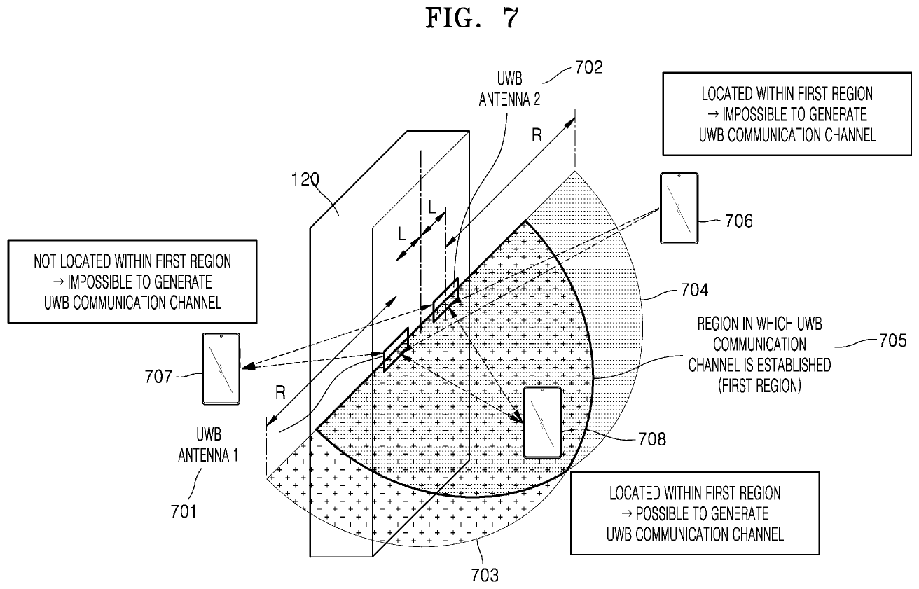

FIG. 7 is a diagram illustrating a location condition of the user terminal 110 according to an embodiment of the disclosure.

In order to generate an UWB communication channel according to an embodiment of the disclosure, a condition is required for the user terminal 110 that needs to be proximate to the household appliance 120. That is, the UWB communication channel may be generated only when a location of the user terminal 110 with respect to the household appliance 120 is within a first region which is a valid region. In FIG. 7, a first region 705 which is a region in which the user terminal 110 needs to be located in order to generate the UWB communication channel will be described.

The household appliance 120 according to an embodiment of the disclosure may include a first UWB antenna 701 and a second UWB antenna 702 in a front surface of the household appliance 120. The first UWB antenna 701 according to an embodiment of the disclosure may be embedded in a location away by L from the center of the household appliance 120 to the left. In addition, the second UWB antenna 702 according to an embodiment of the disclosure may be embedded in a location away by L from the center of the household appliance 120 to the right. The first UWB antenna 701 and the second UWB antenna 702 according to an embodiment of the disclosure may be located in parallel at the same height.

The user terminal 110 according to an embodiment of the disclosure may send a device registration request signal through an UWB antenna embedded in the user terminal 110. The sent device connection request signal may be received by the first UWB antenna 701 and the second UWB antenna 702 embedded in the household appliance 120. In FIG. 7, each of dotted lines from user terminals 706, 707, and 708 to the first UWB antenna 701 and the second UWB antenna 702 indicates the device registration request signal transferred from the user terminal 110 to the household appliance 120.

The first region 705 which is the region in which the user terminal 110 needs to be located according to an embodiment of the disclosure may correspond to a certain region of the front surface of the household appliance 120. Here, the certain region of the front surface of the household appliance 120 may mean a region 705 in which a semicircular range 703 formed with respect to the first UWB antenna 701 and a semicircular range formed with respect to the second UWB antenna 702 overlap.

The first UWB antenna 701 according to an embodiment of the disclosure may recognize the semicircular range 703 having a radius R of the front surface of the household appliance 120 with respect to the first UWB antenna 701 as a valid region. The second UWB antenna 702 according to an embodiment of the disclosure may recognize the semicircular range 704 having the radius R of the front surface of the household appliance 120 with respect to the second UWB antenna 702 as a valid region. Accordingly, the first region 705 which is a region recognized as the valid region by the first UWB antenna 701 and the second UWB antenna 702 simultaneously may be a region in which the region 703 which may be recognized as the valid region by the first UWB antenna 701 and the region 704 which may be recognized as the valid region by the second UWB antenna 702 overlap.

According to an embodiment of the disclosure, an UWB communication channel may be generated only when the user terminal 110 is located within the first region 705. Referring to FIG. 7, in the case of the user terminal 708 located within the first region 705, the UWB communication channel may be generated between the household appliance 120 and the user terminal 708 in response to a device connection request. However, in the case of the user terminal 706 located on the front of the household appliance 120 but located outside the first region 705, even when the user terminal 706 transfers the device connection request to the household appliance 120, the UWB communication channel may not be generated. Similarly, in the case of the user terminal 707 located on a rear surface of the household appliance 120 and located other than the first region 705, even when the user terminal 707 transfers the device connection request to the household appliance 120, the UWB communication channel may not be generated.

FIG. 8 is a diagram illustrating a method of measuring a location of the user terminal 110 by coordinates according to an embodiment of the disclosure.

In FIG. 8, a method of obtaining two-dimensional coordinates of the user terminal 110 defined on the same plane as those of a first UWB antenna 801 and a second UWB antenna 802 will be described. FIG. 8 illustrates the household appliance 120 seen down from above.

According to an embodiment of the disclosure, coordinates of the first UWB antenna 801 may be (x1, y1) 803, and coordinates of the second UWB antenna 802 may be (x2, y2) 804. At this time, a first angle that is an incident angle of a device connection request signal received from the user terminal 110 to the first UWB antenna 801 may be a. A second angle that is an incident angle of a device connection request signal received from the user terminal 110 to the second UWB antenna 802 may be β.

At this time, coordinates (x,y) 805 of the user terminal 110 may be formulated by the coordinates 803 of the first UWB antenna 801, the coordinates 804 of the second UWB antenna 802, the first angle x,y and the second angle <<mth2>>.

$$\{ \begin{matrix}y 1 - y = ( x 1 - x ) tan α \\ y 2 - y = ( x 2 - x ) tan β\end{matrix}$$

The equation may be converted as follows.

Cambria Math

The first angle α and the second angle may be converted as follows.

$$\{ \begin{matrix}α = θ1 - 180 ° \\ β = θ2 - 180 °\end{matrix}$$

In conclusion, (x, y) 805 which is the coordinate of the user terminal 110 may be calculated by the following formula.

$$\{ \begin{matrix}x = \frac{x 1 tan θ1 - x 2 tan θ2}{tan θ1 - tan θ2} \\ y = y 2 - \frac{( x 2 - x1 ) tan θ1 tan θ2}{tan θ1 - tan θ2}\end{matrix}$$

FIG. 9 is a flowchart illustrating a method, performed by the user terminal 110, of transferring Wi-Fi network access information according to an embodiment of the disclosure.

FIG. 9 is a diagram illustrating a process after an UWB communication channel is generated between the user terminal 110 and the household appliance 120.

In operation S901, the user terminal 110 according to an embodiment of the disclosure may determine a network that the user terminal 110 is accessing.

According to an embodiment of the disclosure, when a valid UWB communication channel is generated between the user terminal 110 and the household appliance 120, the user terminal 110 may determine a type of the network that the user terminal 110 is currently accessing. For example, the user terminal 110 may determine whether the user terminal 110 is currently accessing a Wi-Fi network or a mobile communication network.

In operation S902, when it is determined that the user terminal 110 is accessing the Wi-Fi network, the user terminal 110 according to an embodiment of the disclosure may transfer Wi-Fi network access information.

For example, when it is determined that the user terminal 110 is accessing AP1, the user terminal 110 may transfer an ID, a password, an authentication method, an encryption method, an authentication key, etc., of AP1 which are information related to AP1, to the household appliance 120 through the generated UWB communication channel.

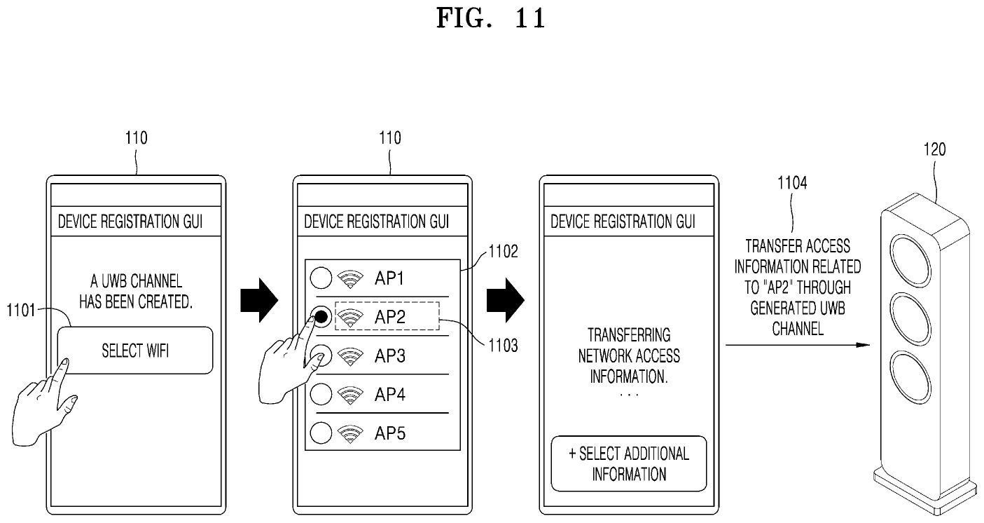

According to an embodiment of the disclosure, the user terminal 110 may receive a user input to select one of Wi-Fi networks accessible by the user terminal 110, without directly transferring the Wi-Fi network that the user terminal 110 is accessing, to the household appliance 120. A detailed method of receiving a user input to select one of the Wi-Fi networks accessible by the user terminal 110 will be described with reference to FIG. 11.

In operation S903, the household appliance 120 according to an embodiment of the disclosure may perform a Wi-Fi network access based on the received Wi-Fi network access information.

According to an embodiment of the disclosure, the household appliance 120 may establish a connection between the AP device 130 and the household appliance 120 related to the received Wi-Fi network access information based on the received Wi-Fi network access information to perform an operation of accessing the network. For example, when the household appliance 120 receives access information related to AP1, the household appliance 120 may establish a connection with an AP1 device using the ID and password of the AP1 device included in the access information. Also, the household appliance 120 may establish a connection with the AP1 device to perform an operation of accessing the network.

In operation S904, the household appliance 120 according to an embodiment of the disclosure may terminate the UWB communication channel, and in operation S905, the household appliance 120 may transfer termination of the UWB communication channel to the user terminal 110.

According to an embodiment of the disclosure, when the household appliance 120 completely accesses the network and it is determined that the household appliance 120 has no further information to receive from the user terminal 110, the household appliance 120 may terminate the UWB communication channel generated between the device 120 and the user terminal 110. According to an embodiment of the disclosure, the household appliance 120 may transfer the termination of the UWB communication channel to the user terminal 110, and when the user terminal 110 receives the termination of the UWB communication channel, the user terminal 110 may terminate the UWB communication channel generated between the device 120 and the user terminal 110.

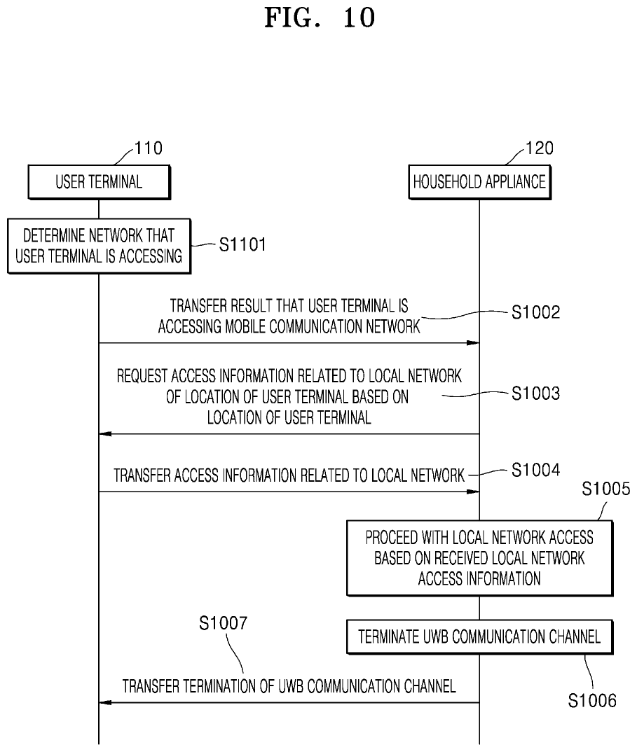

FIG. 10 is a flowchart illustrating a method, performed by the user terminal 110, of transferring local network access information according to an embodiment of the disclosure.

FIG. 10 is a diagram illustrating a process after an UWB communication channel is generated between the user terminal 11 and the household appliance 120.

In operation S1001, the user terminal 110 according to an embodiment of the disclosure may determine a network that the user terminal 110 is accessing.

According to an embodiment of the disclosure, when the valid UWB communication channel is generated between the user terminal 110 and the household appliance 120, the user terminal 110 may determine a type of the network that the user terminal 110 is currently accessing. For example, the user terminal 110 may determine whether the user terminal 110 is currently accessing a Wi-Fi network or a mobile communication network.

In operation S1002, the user terminal 110 according to an embodiment of the disclosure may transfer a result that the user terminal 110 is accessing the mobile communication network to the household appliance 120.

According to an embodiment of the disclosure, when the user terminal 110 does not access the Wi-Fi network, the user terminal 110 may determine that the user terminal 110 is accessing the mobile communication network. The user terminal 110 may transfer the result that the user terminal 110 is accessing the mobile communication network to the household appliance 120 through the generated UWB communication channel when there is no AP device 130, which is a Wi-Fi router, that the user terminal 110 is currently accessing.

In operation S1003, the household appliance 120 according to an embodiment of the disclosure may transfer a request for access information related to a local network of a location of the user terminal 110 to the user terminal 110 based on the location of the user terminal 110.

According to an embodiment of the disclosure, the user terminal 110 may include information about a local network accessible at the location of the user terminal 110 based on location information of the user terminal 110. The household appliance 120 that receives the result that the user terminal 110 is accessing the mobile communication network from the user terminal 110 may request the information about a local network accessible by the user terminal 110 from the user terminal 110 through the generated UWB communication channel.

In operation S1004, the user terminal 110 according to an embodiment of the disclosure may transfer the access information related to the local network to the household appliance 120.

The local network according to an embodiment of the disclosure may be a Wi-Fi network accessible by the user terminal 110 at the location of the user terminal 110.

For example, based on the location information of the user terminal 110, when a Wi-Fi router accessible by the user terminal 110 is an AP2 device, the user terminal 110 may transfer an ID, a password, an authentication method, an encryption method, an authentication key, etc. of AP2 which is information related to the AP2 device to the household appliance 120 through the generated UWB communication channel.

According to an embodiment of the disclosure, when a plurality of Wi-Fi routers accessible by the user terminal 110 are, the user terminal 110 may receive a user input to select one of the plurality of Wi-Fi routers. A specific method of receiving a user input to select one of a plurality of Wi-Fi routers accessible by the user terminal 110 will be described with reference to FIG. 11.

In operation S1005, the household appliance 120 according to an embodiment of the disclosure may perform a local network access based on the received local network access information.

For example, when the household appliance 120 receives access information related to the AP2 device, the household appliance 120 may establish a connection with the AP2 device using the ID and password of the AP2 device included in the access information. Also, the household appliance 120 may establish a connection with the AP2 device and perform an operation of accessing the network.

In operation S1006, the household appliance 120 according to an embodiment of the disclosure may terminate the UWB communication channel, and in operation S1007, the household appliance 120 may transfer termination of the UWB communication channel to the user terminal 110.

The descriptions of operations S1006 and S1007 are the same as those of operations S904 and S905, and thus descriptions thereof will be omitted.

FIG. 11 is a diagram illustrating an operation in which the household appliance 120 receives Wi-Fi network access information from a user through a device registration GUI according to an embodiment of the disclosure.

In FIG. 11, a case where the user terminal 110 receives a user input to select AP2 with the strongest signal from among Wi-Fi networks AP1, AP2, AP3, AP4, and AP5 accessible by the user terminal 110, and transfers access information related to the selected AP2 to the household appliance 120 will be described as an example.

Even when the user terminal 110 is currently accessing AP1 among the Wi-Fi networks, the user terminal 110 does not directly transfer the access information related to AP1 to the household appliance 120, but may receive the user input to select AP2 with the strongest signal from among the Wi-Fi networks AP1, AP2, AP3, AP4, and AP5 accessible by the user terminal 110. In addition, when the user terminal 110 is accessing a mobile communication network, the user terminal 110 may receive the user input to select Wi-Fi network with the strongest signal from among the accessible Wi-Fi networks AP1, AP2, AP3, AP4, and AP5 at a location of the user terminal 110.

Referring to FIG. 11, when an UWB communication channel is generated between the household appliance 120 and the user terminal 110, and the household appliance 120 is ready to receive network access information from the user terminal 110, the device registration GUI may display a phrase “UWB channel has been created”. In addition, the device registration GUI may include a WiFi selection icon 1101 selecting one of the WiFi networks AP1, AP2, AP3, AP4, and AP5 accessible by the user terminal 110.

According to an embodiment of the disclosure, when the user wants to transfer access information of a Wi-Fi network other than the Wi-Fi network that the user terminal 110 is accessing to the household appliance 120, the user may touch the WiFi selection icon 1101 displayed on the device registration GUI. In addition, according to an embodiment of the disclosure, when the user terminal 110 needs to transfer local network access information to the household appliance 120 because the user terminal 110 is accessing the mobile communication network, and the user needs to select one of a plurality of local networks because the plurality of local networks are accessible by the user terminal 110, the user may touch the WiFi selection icon 1101 displayed on the device registration GUI.

When the user terminal 110 receives a user input to touch the WiFi selection icon 1101, a screen of the device registration GUI may display a list 1102 of the WiFi networks AP1, AP2, AP3, AP4, and AP5 accessible by the user terminal 110. Referring to FIG. 11, the device registration GUI may display the WiFi networks AP1, AP2, AP3, AP4, and AP5 accessible by the user terminal 110 and Wi-Fi strengths thereof.

According to an embodiment of the disclosure, the user terminal 110 may receive a user input 1103 to select one from the list 1102 of the WiFi networks AP1, AP2, AP3, AP4, and AP5 accessible by the user terminal 110. For example, in the Wi-Fi networks AP1 to AP5, when the signal of AP2 is displayed as the strongest signal, the user may wish to transfer access information of AP2 having the strongest signal to the household appliance 120. When the user wishes to transfer the access information of AP2 to the household appliance 120, the user may input to select AP2.

According to an embodiment of the disclosure, when the user terminal 110 receives a user input 1103 to select one from the list 1102 of the WiFi networks AP1, AP2, AP3, AP4, and AP5, the user terminal 110 may transfer access information related to the selected Wi-Fi network to the household appliance 120. For example, when the user selects AP2, the user terminal 110 may transfer an ID, a password, an authentication method, an encryption method, an authentication key, etc., of AP2 which are access information related to AP2 to the household appliance 120 through the generated UWB communication channel (1104).

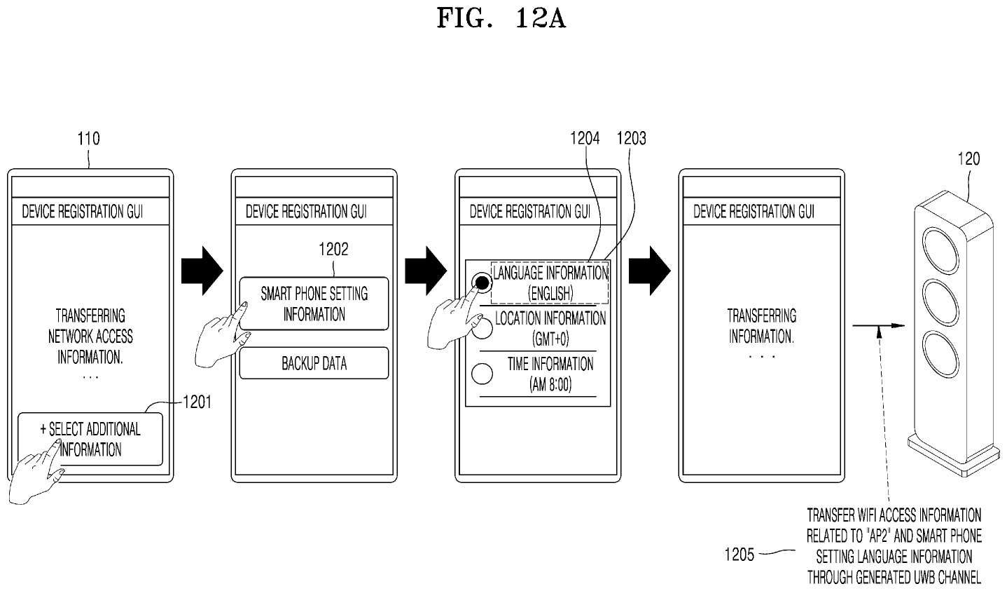

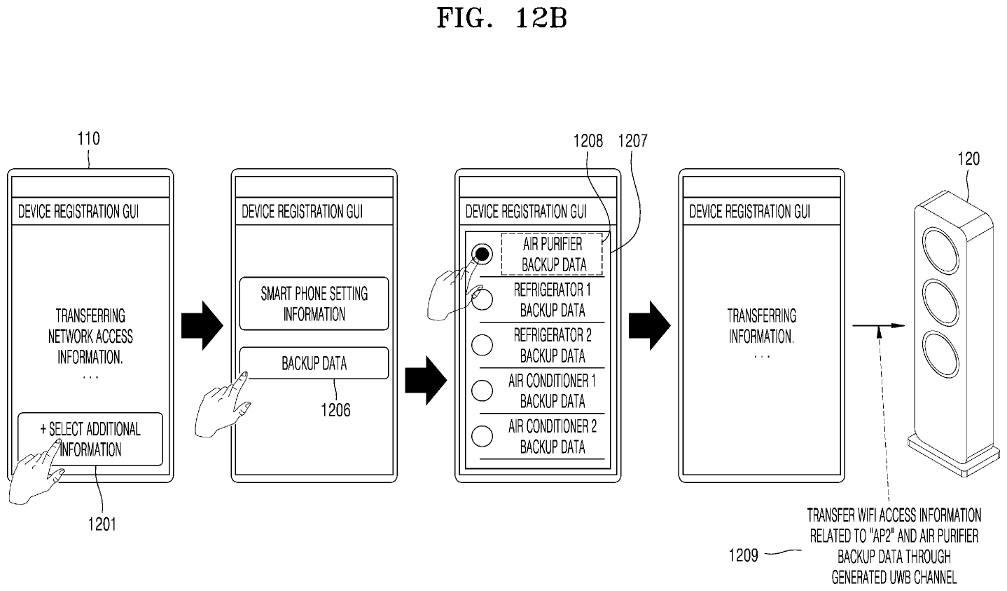

FIG. 12A is a diagram illustrating an operation in which the household appliance 120 receives attribute information of the household appliance 120 from a user through a device registration GUI according to an embodiment of the disclosure.

In FIG. 12A, an operation in which the user terminal 110 transfers setting information of the user terminal 110 determining the attribute information of the household appliance 120 together with network access information to the household appliance 120 through an UWB communication channel will be described.

The household appliance 120 in a network setting process is highly likely to be in a new product state. Because the attribute information of the household appliance 120 in the new product state has not been set, the user needs to directly manipulate the household appliance 120 to set the attribute information. For example, the user may directly operate a button of the household appliance 120 to set location information, language information, and time information of the household appliance 120. However, a type of button setting the attribute information may be different for each household appliance 120, which may make it difficult for the user to directly set the attribute information. Accordingly, the user terminal 110 according to an embodiment of the disclosure may transfer the attribute information of the household appliance 120 together with the network access information to the household appliance 120. The user terminal 110 may set the attribute information of the household appliance 120, by transferring the setting information of the user terminal 110. For example, when the user transfers information of the user terminal 110 of which language is set to English to the household appliance 120, attribute information related to the language of the household appliance 120 may be set to English.

Referring to FIG. 12A, the user may touch an icon 1201 “select additional information” displayed on the device registration GUI in order to transfer the setting information of the user terminal 110 together with the network access information to the household appliance 120. When the user terminal 110 according to an embodiment of the disclosure receives a user input to touch an icon 1202 “smartphone setting information” from the user, the user terminal 110 may display a setting information list 1203 of the user terminal 110 on a screen of the device registration GUI. Referring to FIG. 12A, the user terminal 110 may display language information (English), location information (GMT+0), and time information (AM 8:00) set by the user in the user terminal 110.

Referring to FIG. 12A, the user terminal 110 may receive a user input 1204 to select one from the list of setting information 1203 of the user terminal 110. For example, when the user wants to set the same language information in the household appliance 120 as set by the user in the user terminal 110, the user may enter an input to select the language information.

According to an embodiment of the disclosure, when the user terminal 110 receives the user input 1204 to select one from the setting information list 1203 of the user terminal 110, the user terminal 110 may transfer the selected user terminal setting information together with the network access information through the UWB communication channel to the household appliance 120 (1305).

FIG. 12B is a diagram illustrating an operation in which the household appliance 120 receives setting information or history information of the same type of household appliance previously used from a user through a device registration GUI according to an embodiment of the disclosure.

In FIG. 12B, an operation in which the user terminal 110 transfers setting information or history information of the same type of household appliance previously used together with network access information to the household appliance 120 through the UWB communication channel will be described.

The household appliance 120 in a network setting process is highly likely to be in a new product state. When the user has previously used the same type of household appliance, and is able to transfer setting information or history information of the used household appliance to the household appliance 120, which is a new product, it may be convenient t to apply the setting information of the previously used household appliance to the household appliance 120 as it is.

Referring to FIG. 12B, in order to transfer the setting information or history information of the household appliance used by the user to the household appliance 120, the user may touch the icon 1201 “select additional information” and an icon 1206 “backup data” displayed on the device registration GUI.

When the user terminal 110 according to an embodiment of the disclosure receives a user input to touch the icon 1206 “backup data” from the user, the user terminal 110 may display a backup data list 1207 that is the history information of the household appliance previously used on a screen of the device registration GUI. Referring to FIG. 12B, the user terminal 110 may display “air purifier backup data”, “refrigerator 1 backup data”, “refrigerator 2 backup data”, “air conditioner 1 backup data”, and “air conditioner 2 backup data”.

Referring to FIG. 12B, the user terminal 110 may receive a user input 1208 to select one from the backup data list 1207. For example, when the household appliance 120 under network setting is an air conditioner, the same type of air conditioner has been used before, and history information of the used air conditioner is stored as “air conditioner 1 backup data”, the user may enter an input to select “air conditioner 1 backup data”.

According to an embodiment of the disclosure, when the user terminal 110 receives the user input 1208 to select one from the backup data list 1207, the user terminal 110 may transfer the selected history information together with network access information through the UWB communication to the household appliance 120 (1209).

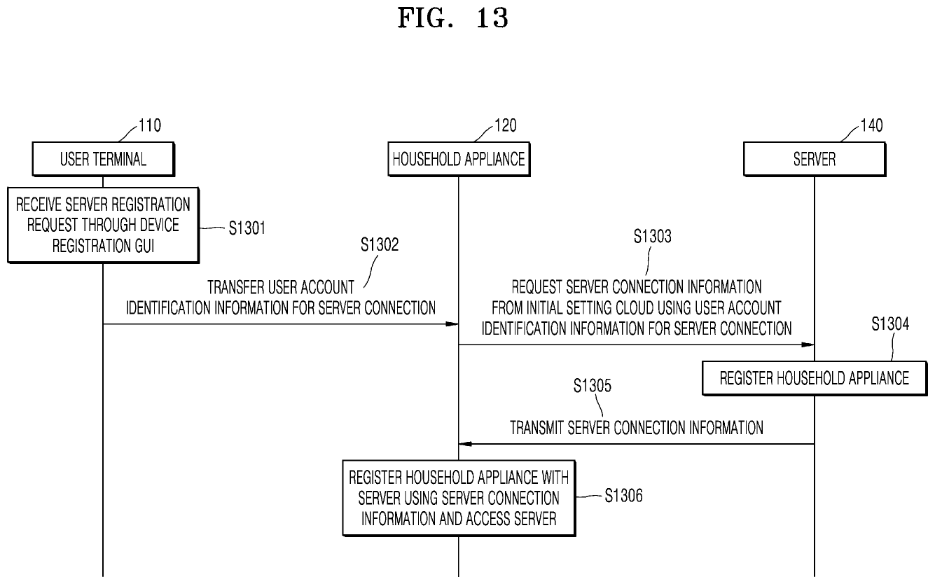

FIG. 13 is a flowchart illustrating a method of registering the household appliance 120 with the server 140 according to an embodiment of the disclosure.

FIG. 13 is a diagram illustrating a process after the user terminal 110 transfers network access information to the household appliance 120 through an UWB communication channel.

In operation S1301, the user terminal 110 according to an embodiment of the disclosure may receive a server registration request through a device registration GUI.

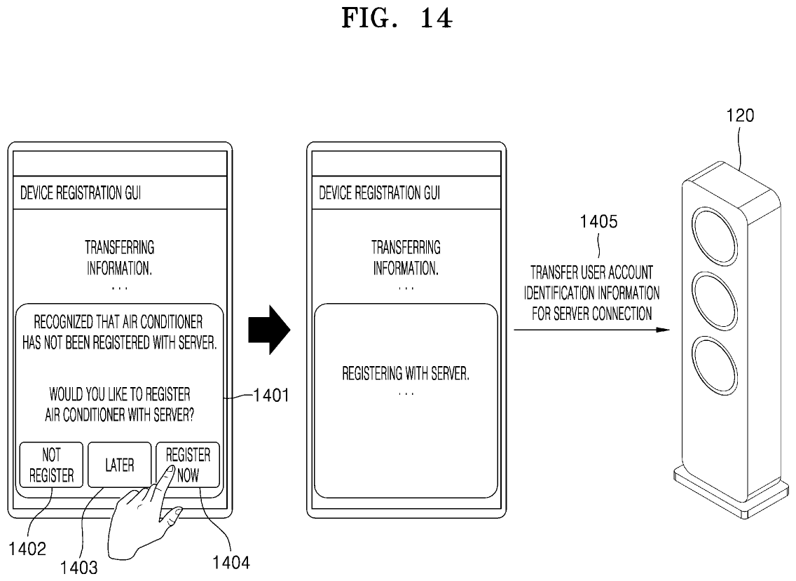

Referring to FIG. 14, when the household appliance 120 is not registered with the server 140, the user terminal 110 may display a guide window including a phrase that the household appliance 120 is not registered with the server 140 on the device registration GUI. For example, during a process of connecting an air conditioner to a network, when the air conditioner is not registered with the server 140, a guide window 1401 including a phrase “The recognized air conditioner has not been registered with the server. Would you like to register the air conditioner with the server?” may be displayed. The guide window 1401 may include an icon 1402 “Not register”, an icon 1403 “Later”, and an icon 1404 “Register now”.

In operation S1302, the user terminal 110 according to an embodiment of the disclosure may transfer user account identification information for a server connection to the household appliance 120.

Referring to FIG. 14, when the user terminal 110 receives a user input to select the icon 1404 “Register now” from the user, the user terminal 110 may transfer user account identification information for connection to the server 140 to the household appliance 120 through an UWB communication channel (1405).

According to an embodiment of the disclosure, the household appliance 120 may receive the user account identification information for connection to the server 140, and may be connected to a certain account of the server 140. Therefore, in order for the household appliance 120 to access the server 140, an ID and a password of an account are required. The user account identification information for connection to the server 140 according to an embodiment of the disclosure may include server access account ID information, server access account password information, server access path information, server account token information, etc.

In operation S1303, the household appliance 120 according to an embodiment of the disclosure may request server connection information from an initial setting cloud using the received user account identification information for the server connection.

In operation S1304, in the user account identification information for the server connection, only when the server access account ID information and the password information are identical to the account information of the server 140, the server 140 may register the household appliance 120 with the certain account of the server 140. In addition, the server 140 may transmit the server connection information to the household appliance 120 in operation S1305.

In operation S1306, the household appliance 120 according to an embodiment of the disclosure may register the household appliance 120 with the server 140 using the server connection information and access the server 140.

The server 140 according to an embodiment of the disclosure may complete a registration procedure of the household appliance 120 by the household appliance 120 accessing the server 140 using the server connection information. After being registered with the server 140, the household appliance 120 may transmit status information, monitoring information, support request, data processing request, etc. of the household appliance 120 to the server 140. Also, after being registered with the server 140, the household appliance 120 may receive a control signal from the server 140 to operate.

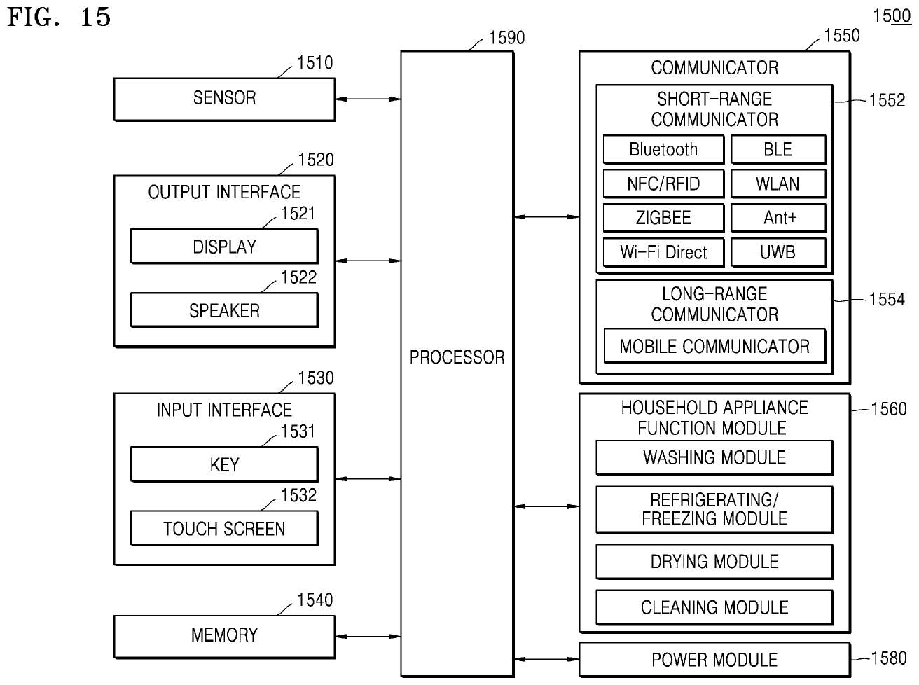

FIG. 15 is a block diagram illustrating a structure of a household appliance 1500 according to an embodiment of the disclosure.

The household appliance 120 according to an embodiment of the disclosure may correspond to the household appliance 1500. The household appliance 1500 according to an embodiment of the disclosure includes a sensor 1510, an output interface 1520, an input interface 1530, a memory 1540, a communicator 1550, a household appliance function module 1560, a power module 1580, and a processor 1590. The household appliance 1500 may be configured as various combinations of components shown in FIG. 15, and all the components shown in FIG. 15 are not indispensable.

The household appliance 1500 of FIG. 15 corresponds to the household appliance 120 described with reference to FIG. 2, the memory 1540 corresponds to the memory 226 described with reference to FIG. 2, the processor 1590 corresponds to the processor 220 described with reference to FIG. 2, and the communicator 1550 corresponds to the communication module 228 described with reference to FIG. 2.

The sensor 1510 may include various types of sensors. For example, the sensor 1510 may include an image sensor, an infrared sensor, an ultrasonic sensor, a lidar sensor, a human detection sensor, a motion detection sensor, a proximity sensor, an illuminance sensor, etc. A function of each sensor may be intuitively inferred from the name by one of ordinary skill in the art, and thus a detailed description thereof will be omitted.

The output interface 1520 may include a display 1521, a speaker 1522, etc. The output interface 1520 outputs various notifications, messages, information, etc. generated by the processor 1590.

The input interface 1530 may include a key 1531, a touch screen 1532, etc. The input interface 1530 receives a user input and transfers the user input to the processor 1590.

The memory 1540 stores various information, data, instructions, programs, etc. necessary for the operation of the household appliance 1500. The memory 1540 may include at least one of a volatile memory or a non-volatile memory, or a combination thereof. The memory 1540 may include at least one type of storage medium among a flash memory type, a hard disk type, a multimedia card micro type, a card type memory (e.g., SD or XD memory, etc.), RAM, SRAM, ROM, EEPROM, PROM, magnetic memory, magnetic disk, or optical disk. Also, the household appliance 2100 may operate a web storage or a cloud server that performs a storage function on the Internet.

The communicator 1550 may include at least one of a short-range communicator 1552 or a long-range communicator 1554 or a combination thereof. The communicator 1550 may include at least one antenna to wirelessly communicate with other devices.

The short-range wireless communicator 1552 a Bluetooth communication module, a BLE communication module, an NFC module, a WLAN (Wi-Fi) communication module, a Zigbee communication module, an IrDA communication module, a WFD communication module, an UWB communication module, an Ant+ communication module, a uWave communication module, etc., but is not limited thereto.

The long-range communicator 1554 may include a communication module performing various types of long-range communication, and may include a mobile communicator. The mobile communicator transmits/receives a wireless signal to and from at least one of a base station, an external terminal, or a server on a mobile communication network. Here, the wireless signal may include various types of data according to transmission/reception of a voice signal, a video call signal, or a text/multimedia message.

The household appliance function module 1560 includes an operation module that performs the original function of the household appliance 1500. When the household appliance 1500 corresponds to a washing machine, the household appliance function module 1560 includes a washing module. The washing module may include a washing tub, a water supply unit, a drainage unit, a motor, a door, a detergent inlet, etc. When the household appliance 1500 corresponds to a refrigerator, the household appliance function module 1560 may include a refrigerating/freezing module. The refrigerating/freezing module may include a container, a cooler, a door, a temperature sensor, etc. When the household appliance 1500 corresponds to a dryer, the household appliance function module 1560 may include a drying module. The drying module may include a laundry container, a motor, a dehumidifying unit, a draining unit, a door, a dust filter, a condenser, etc. When the household appliance 1500 corresponds to a cleaner, the household appliance function module 1560 may include a cleaning module. The cleaning module may include a vacuum suction unit, a dust container, a filter, a dust moving pipe, etc.

The processor 1590 controls the overall operation of the household appliance 1500. The processor 1500 may execute a program stored in the memory 1540 to control components of the household appliance 1500.

According to an embodiment of the disclosure, the processor 1590 may include a separate neural processing unit (NPU) performing the operation of a machine learning model. In addition, the processor 1590 may include a central processing unit (CPU), a graphics processing unit (GPU), etc.

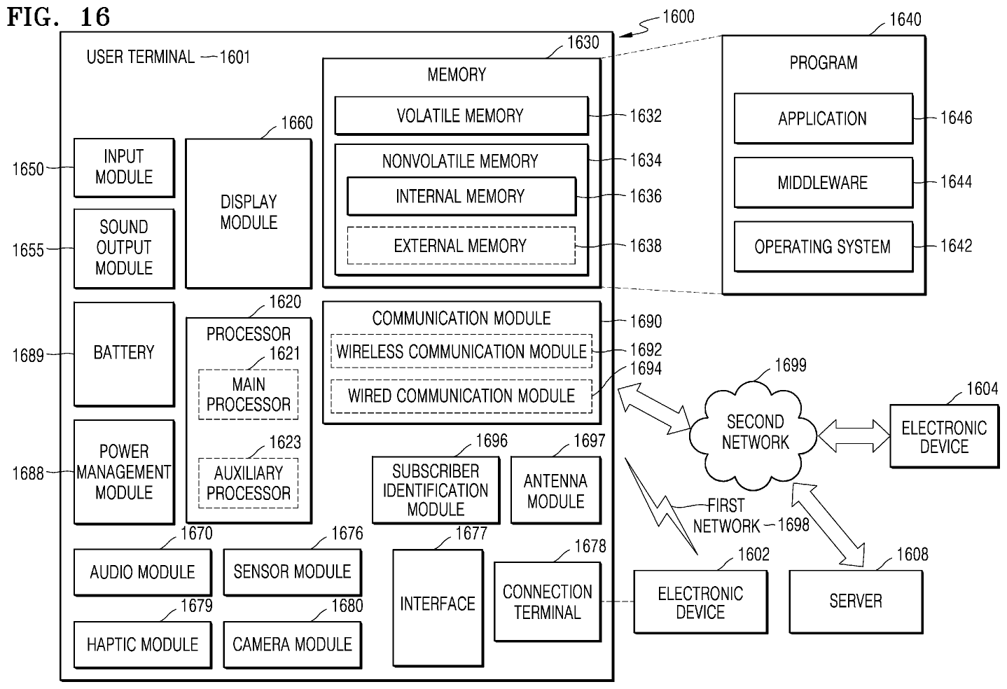

FIG. 16 is a block diagram of a user terminal 1601 in a network environment 1600, according to various embodiments of the disclosure.

The user terminal 1601 of FIG. 16 may correspond to the user terminal 110 described above. In addition, the processor 210 described with reference to FIG. 2 may correspond to a processor 1620, and the communication module 212 described with reference to FIG. 2 may correspond to a communication module 1690. In addition, the user terminal memory 214 described with reference to FIG. 2 corresponds to a memory 1630, and the input/output interface 216 described with reference to FIG. 2 may correspond to an input module 1650, a sound output module 1655, a display module 1660, an audio module 1670, and a haptic module 1679. Also, the household appliance 120 may correspond to an electronic device 1602 or an electronic device 1604.

Referring to FIG. 16, in the network environment 1600, the user terminal 1601 may communicate with the electronic device 1602 through a first network 1698 (e.g., a short-range wireless communication network) or may communicate with at least one of the electronic device 1604 or a server 1608 through a second network 1699 (e.g., a long-range wireless communication network). According to an embodiment of the disclosure, the user terminal 1601 may communicate with the electronic device 1604 through the server 1608. According to an embodiment of the disclosure, the user terminal 1601 may include the processor 1620, the memory 1630, the input module 1650, the sound output module 1655, the display module 1660, the audio module 1670, a sensor module 1676, an interface 1677, a connection terminal 1678, the haptic module 1679, a camera module 1680, a power management module 1688, a battery 1689, a communication module 1690, a subscriber identification module 1696, or an antenna module 1697. In some embodiments of the disclosure, at least one (e.g., the connection terminal 1678) of these components may be omitted or one or more other components may be added to the user terminal 1601. In some embodiments of the disclosure, some (e.g., the sensor module 1676, the camera module 1680, or the antenna module 1697) of these components may be integrated into one component (e.g., the display module 1660).

The processor 1620, for example, may execute software (e.g., the program 1640) to control at least one other component (e.g., a hardware or software component) of the user terminal 1601 connected to the processor 1620 and perform various data processing or operations. According to an embodiment of the disclosure, as at least part of data processing or operation, the processor 1620 may store command or data received from another component (e.g., the sensor module 1676 or the communication module 1690) in the volatile memory 1632, process the command or data stored in the volatile memory 1632, and store resultant data in the non-volatile memory 1634. According to an embodiment of the disclosure, the processor 1620 may include a main processor 1621 (e.g., a central processing unit or an application processor) or an auxiliary processor 1623 (e.g., a graphics processing unit, a neural processing unit (NPU), an image signal processor, a sensor hub processor, or a communication processor) operable independently from or together with the main processor 1621. For example, when the user terminal 1601 includes the main processor 1621 and the auxiliary processor 1623, the auxiliary processor 1623 may use less power than the main processor 1621, or may be set to be specialized for a specified function. The auxiliary processor 1623 may be implemented separately from or as part of the main processor 1621.

The auxiliary processor 1623 may, for example, on behalf of the main processor 1621 while the main processor 1621 is in an inactive state (e.g., sleep), or together with the main processor 1621 while the main processor 1621 is in an active state (e.g., executing an application, control at least some of functions or states related to at least one (e.g., the display module 1660, the sensor module 1676, or the communication module 1690) of the components of the user terminal 1601. According to an embodiment of the disclosure, the auxiliary processor 1623 (e.g., an image signal processor or communication processor) may be implemented as part of another functionally related component (e.g., the camera module 1680 or the communication module 1690). According to an embodiment of the disclosure, the auxiliary processor 1623 (e.g., a neural network processing unit) may include a hardware structure specialized for processing an artificial intelligence model. The artificial intelligence model may be generated through machine learning. Such training may be performed, for example, in the user terminal 1601 itself on which the artificial intelligence model training is performed, or may be performed through a separate server (e.g., the server 1608). Examples of the learning algorithm may include supervised learning, unsupervised learning, semi-supervised learning, and reinforcement learning, but are not limited thereto. The artificial intelligence model may include a plurality of artificial neural network layers. Examples of an artificial neural network may include deep neural network (DNN), convolutional neural network (CNN), recurrent neural network (RNN), restricted boltzmann machine (RBM), deep belief network (DBN), bidirectional recurrent deep neural network (BRDNN), deep Q-network or a combination of two or more of the above, but are not limited thereto. The artificial intelligence model may include, additionally or alternatively, a software structure besides the hardware structure.

The memory 1630 may store various data used by at least one component (e.g., the processor 1620 or the sensor module 1676) of the user terminal 1601. The data may include, for example, input data or output data for software (e.g., a program 1640) and command related thereto. The memory 1630 may include the volatile memory 1632 or the non-volatile memory 1634.

The program 1640 may be stored as software in the memory 1630, and may include, for example, an operating system 1642, middleware 1644, or an application 1646.

The input module 1650 may receive a command or data to be used in a component (e.g., the processor 1620) of the user terminal 1601 from the outside (e.g., a user) of the user terminal 1601. The input module 1650 may include, for example, a microphone, a mouse, a keyboard, a key (e.g., a button), or a digital pen (e.g., a stylus pen).

The sound output module 1655 may output a sound signal to the outside of the user terminal 1601. The sound output module 1655 may include, for example, a speaker or a receiver. The speaker may be used for general purposes such as multimedia playback or recording playback. The receiver may be used to receive an incoming call. According to an embodiment of the disclosure, the receiver may be implemented separately from or as part of the speaker.

The display module 1660 may visually provide information to the outside (e.g., a user) of the user terminal 1601. The display module 1660 may include, for example, a control circuit for controlling a display, a hologram device, or a projector and a corresponding device. According to an embodiment of the disclosure, the display module 1660 may include a touch sensor configured to sense a touch or a pressure sensor configured to measure the intensity of a force generated by the touch.

The audio module 1670 may convert a sound into an electric signal or, conversely, convert an electric signal into a sound. According to an embodiment of the disclosure, the audio module 1670 may obtain a sound through the input module 1650 or output a sound through a sound output module 1655 or an external electronic device (e.g., the electronic device 1602) (e.g., a speaker or a headphone) directly or wirelessly connected to the user terminal 1601.

The sensor module 1676 may detect an operating state (e.g., power or temperature) of the user terminal 1601 or an external environmental state (e.g., a user state), and generate an electrical signal or a data value corresponding to the detected state. According to an embodiment of the disclosure, the sensor module 1676 may include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1677 may support one or more specified protocols that may be used for the user terminal 1601 to be directly or wirelessly connected to an external electronic device (e.g., the electronic device 1602). According to an embodiment of the disclosure, the interface 1677 may include, for example, a high definition multimedia interface (HDMI), a universal serial bus (USB) interface, an SD card interface, or an audio interface.

The connection terminal 1678 may include a connector through which the user terminal 1601 may be physically connected to an external electronic device (e.g., the electronic device 1602). According to an embodiment of the disclosure, the connection terminal 1678 may include, for example, an HDMI connector, a USB connector, an SD card connector, or an audio connector (e.g., a headphone connector).

The haptic module 1679 may convert an electrical signal into a mechanical stimulus (e.g., vibration or movement) or an electrical stimulus that the user may perceive through tactile or kinesthetic sense. According to an embodiment of the disclosure, the haptic module 1679 may include, for example, a motor, a piezoelectric element, or an electrical stimulation device.

The camera module 1680 may capture still images and moving images. According to an embodiment of the disclosure, the camera module 1680 may include one or more lenses, image sensors, image signal processors, or flashes.

The power management module 1688 may manage power supplied to the user terminal 1601. According to an embodiment of the disclosure, the power management module 1688 may be implemented as, for example, at least a part of a power management integrated circuit (PMIC).

The battery 1689 may supply power to at least one component of the user terminal 1601. According to an embodiment of the disclosure, the battery 1689 may include, for example, a non-rechargeable primary cell, a rechargeable secondary cell, or a fuel cell.

The communication module 1690 may establish a direct (e.g., wired) communication channel or a wireless communication channel between the user terminal 1601 and an external electronic device (e.g., the electronic device 1602, the electronic device 1604, or the server 1608) and may support communication through the established communication channel. The communication module 1690 may include one or more communication processors that operate independently from the processor 1620 (e.g., an application processor) and support direct (e.g., wired) communication or wireless communication. According to an embodiment of the disclosure, the communication module 1690 may include a wireless communication module 1692 (e.g., a cellular communication module, a short-range wireless communication module, or a global navigation satellite system (GNSS) communication module) or a wired communication module 1694 (e.g., a local area network (LAN) communication module, or a power line communication module). A corresponding communication module among these communication modules may communicate with the external electronic device 1604 through a first network 1698 (e.g., a short-range communication network such as Bluetooth, wireless fidelity (WiFi) direct, or infrared data association (IrDA)) or a second network 1699 (e.g., a long-range communication network such as a legacy cellular network, a 5G network, a next-generation communication network, the Internet, or a computer network (e.g., LAN or WAN). These various types of communication modules may be integrated into one component (e.g., a single chip) or may be implemented as a plurality of components (e.g., multiple chips) separate from each other. The wireless communication module 1692 may use subscriber information (e.g., International Mobile Subscriber Identifier (IMSI)) stored in the subscriber identification module 1696 to check or authenticate the user terminal 1601 within a communication network, such as the first network 1698 or the second network 1699.

The wireless communication module 1692 may support a 5G network after a 4G network and a next-generation communication technology, for example, a new radio (NR) access technology. NR access technology may support high-speed transmission of high-capacity data (enhanced mobile broadband (eMBB)), minimization of terminal power and access to multiple terminals (massive machine type communications (mMTC)), or high reliability and low latency (ultra-reliable and low-latency communications (URLLC)). The wireless communication module 1692 may support, for example, a high frequency band (e.g., mmWave band) to achieve a high data rate. The wireless communication module 1692 may support various technologies for securing performance in a high frequency band, for example, beamforming, massive multiple-input and multiple-output (MIMO), full dimensional MIMO (FD-MIMO), array antenna, analog beam-forming, or large scale antenna. The wireless communication module 1692 may support various requirements specified in the user terminal 1601, an external electronic device (e.g., the electronic device 1604), or a network system (e.g., the second network 1699). According to an embodiment of the disclosure, the wireless communication module 1692 may support a peak data rate (e.g., equal to or more than 20 Gbps) for realization of eMBB, loss coverage (e.g., equal to or less than 164 dB) for realization of mMTC, or U-plane latency for realization of URLLC (e.g.: downlink (DL) and uplink (UL) each equal to or less than 0.5 ms, or equal to or less than 1 ms of round trip).

The antenna module 1697 may transmit or receive a signal or power to the outside (e.g., an external electronic device). According to an embodiment of the disclosure, the antenna module 1697 may include an antenna including a conductor formed on a substrate (e.g., a printed circuit board (PCB)) or a radiator formed in a conductive pattern. According to an embodiment of the disclosure, the antenna module 1697 may include a plurality of antennas (e.g., array antennas). In this case, at least one antenna suitable for a communication method used in a communication network such as the first network 1698 or the second network 1699 may be selected from the plurality of antennas by, for example, the communication module 1690. A signal or power may be transmitted or received between the communication module 1690 and an external electronic device through the selected at least one antenna. According to some embodiments of the disclosure, other components (e.g., a radio frequency integrated circuit (RFIC)) other than the radiator may be additionally formed as a part of the antenna module 1697.

According to various embodiments of the disclosure, the antenna module 1697 may form a mmWave antenna module. According to an embodiment of the disclosure, the mmWave antenna module may include a PCB, an radio frequency integrated circuit (RFIC) disposed on or adjacent to a first surface (e.g., a lower surface) of the PCB and capable of supporting a designated high frequency band (e.g., an mmWave band) and a plurality of antennas (e.g., array antennas) disposed on or adjacent to a second surface (e.g., an upper surface or a side surface) of the PCB and capable of transmitting or receiving signals of the designated high frequency band.

At least some of the components may be connected to each other through a communication method (e.g., a bus, general purpose input and output (GPIO), serial peripheral interface (SPI), or mobile industry processor interface (MIPI)) between peripheral devices and may exchange signals (e.g., command or data) with each other.

According to an embodiment of the disclosure, the command or data may be transmitted or received between the user terminal 1601 and the external electronic device 1604 through the server 1608 connected to the second network 1699. Each of the external electronic devices 1602 or 1604 may be the same type as or a different type of device from the user terminal 1601. According to an embodiment of the disclosure, all or part of the operations executed by the user terminal 1601 may be executed by one or more of the external electronic devices 1602, 1604, or 1608. For example, when the user terminal 1601 needs to perform a certain function or service automatically or in response to a request from a user or other device, the user terminal 1601 may request one or more external electronic devices to perform at least part of the function or the service, instead of executing the function or service by itself or additionally. The o or more external electronic devices that receive such a request may execute at least a part of the requested function or service, or an additional function or service related to the request, and transfer an execution result to the user terminal 1601. The user terminal 1601 may process the result as it is or additionally and provide the processed result as at least a part of a response to the request. To this end, for example, cloud computing, distributed computing, mobile edge computing (MEC), or client-server computing technology may be used. The user terminal 1601 may provide an ultra-low latency service using, for example, distributed computing or mobile edge computing. In another embodiment of the disclosure, the external electronic device 1604 may include an Internet of things (IoT) device. The server 1608 may be an intelligent server using machine learning and/or neural network. According to an embodiment of the disclosure, the external electronic device 1604 or the server 1608 may be included in the second network 1699. The user terminal 1601 may be applied to an intelligent service (e.g., smart home, smart city, smart car, or health care) based on 5G communication technology and IoT-related technology.

As used in various embodiments of the disclosure, the term “module” or “-er/-or” may include a unit implemented in hardware, software, or firmware, and may be used interchangeably with the term, for example, logic, logic block, component, or circuit. The module may be an integrally configured component or a minimum unit or a part of the component that performs one or more functions. For example, according to an embodiment of the disclosure, the module may be implemented in the form of an application-specific integrated circuit (ASIC).

Various embodiments of the disclosure may be implemented as software (e.g., a program) including one or more instructions stored in a storage medium readable by machine (e.g., the user terminal 110 or the household appliance 120). For example, a processor of the machine (e.g., the user terminal 110 or the household appliance 120 may call at least one of the stored one or more instructions from the storage medium and execute the called at least one instruction. This makes it possible for the machine to perform at least one function according to the called at least one instruction. The one or more instructions may include code generated by a compiler or code executable by an interpreter. The machine-readable storage medium may be provided in the form of a non-transitory storage medium. When the storage medium is ‘non-transitory’, it means that the storage medium is tangible and does not include signals (e.g., electromagnetic waves), and it does not limit that data is semi-permanently or temporarily stored in the storage medium.

According to an embodiment of the disclosure, the method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be online distributed (e.g., downloaded or uploaded) via an application store (e.g., Play Store™) or directly between two user devices (e.g., smartphones). For online distribution, at least a part of the computer program product (e.g., a downloadable app) may be temporarily generated or be at least temporarily stored in a machine-readable storage medium, e.g., a memory of a server of a manufacturer, a server of an application store, or a relay server.

According to various embodiments of the disclosure, each element (e.g., a module or a program) of the above-described elements may include a singular or a plurality of entities, and some of the plurality of entities may be separately disposed in the other elements. According to various embodiments of the disclosure, one or more elements or operations may be omitted from among the above-described corresponding elements, or one or more other elements or operations may be added. Alternatively or additionally, a plurality of elements (e.g., modules or programs) may be integrated into one element. In this case, the integrated element may perform one or more functions of each element of the plurality of element identically or similarly to those performed by the corresponding element among the plurality of element prior to integration. According to various embodiments of the disclosure, operations performed by the module, the program, or another element may be executed sequentially, in parallel, repeatedly, or heuristically, one or more operations of the operations may be executed in a different order or omitted, or one or more other operations may be added.

What is claimed is:

1. A method of controlling a household appliance, the method comprising:
receiving a device connection request signal through ultra wideband (UWB) communication from a user terminal;
obtaining location information of the user terminal based on the received device connection request signal;
establishing a UWB communication channel between the household appliance and the user terminal based on the obtained location information;
receiving network access information to access a network from the user terminal through the established UWB communication channel; and
establishing a network connection for the household appliance to access the network based on the received network access information.

2. The method of claim 1, wherein the obtaining of the location information of the user terminal comprises:
measuring an angle at which the device connection request signal is received through a first UWB antenna and a second UWB antenna included in the household appliance; and
based on the measured angle, obtaining coordinates representing the location information of the user terminal.

3. The method of claim 2, wherein the establishing of the UWB communication channel between the household appliance and the user terminal based on the obtained location information comprises:
determining whether the coordinates representing the location information of the user terminal are within a first region from the household appliance; and
wherein the UWB communication channel between the household appliance and the user terminal is established when the coordinates representing location information of the user terminal are determined to be within the first region from the household appliance.

4. The method of claim 1, wherein the network access information comprises information about an access point (AP) that is accessible, a password with respect to the AP, and a security setting.

5. The method of claim 1, wherein the receiving of the network access information to access the network from the user terminal comprises: receiving access information related to a Wi-Fi network that the user terminal is accessing.

6. The method of claim 1, wherein the receiving of the network access information to access the network from the user terminal comprises:
receiving a result of determining that the user terminal is accessing a mobile communication network;
requesting access information related to a local network in which the user terminal is located based on a location of the user terminal; and
receiving the access information related to the local network.

7. The method of claim 1, wherein the receiving of the network access information to access the network from the user terminal through the established UWB communication channel further comprises: receiving, from the user terminal, user account identification information for a server connection.

8. The method of claim 1, wherein the receiving of the network access information to access the network from the user terminal through the established UWB communication channel further comprises: receiving attribute information of the household appliance from the user terminal.

9. The method of claim 8, wherein the attribute information of the household appliance comprises: at least one of location information, time information, or language information of the household appliance previously set by a user through the user terminal.

10. The method of claim 1, wherein the receiving of the network access information to access the network from the user terminal through the established UWB communication channel further comprises: receiving, from the user terminal, setting information or history information of a same type of a household appliance previously used by a user.

11. A household appliance comprising:
at least one ultra wideband (UWB) antenna;
a UWB communication module configured to perform short-range wireless communication with a user terminal;
a network communication module configured to access a network and wirelessly transmit and receive data;
a memory storing one or more instructions; and
at least one processor connected to the memory, wherein the at least one processor is configured to execute the one or more instructions to:
receive a device connection request signal through UWB communication from the user terminal;
obtain location information of the user terminal based on the received device connection request signal;
establish a UWB communication channel between the household appliance and the user terminal based on the obtained location information;
receive network access information to access a network from the user terminal through the established UWB communication channel; and
establish a network connection for the household appliance to access the network based on the received network access information.

12. The household appliance of claim 11, wherein, to obtain the location information of the user terminal, the at least one processor is further configured to execute the one or more instructions to:
measure an angle at which the device connection request signal is received through a first UWB antenna and a second UWB antenna included in the household appliance; and
based on the measured angle, obtain coordinates representing the location information of the user terminal.

13. The household appliance of claim 12, wherein, to establish the UWB communication channel between the household appliance and the user terminal based on the obtained location information, the at least one processor is further configured to execute the one or more instructions to:
determine whether the coordinates representing the location information of the user terminal are within a first region from the household appliance; and
establish the UWB communication channel between the household appliance and the user terminal when the coordinates are determined to be within the first region from the household appliance.

14. The household appliance of claim 11, wherein, to receive the network access information to access the network from the user terminal, the at least one processor is further configured to execute the one or more instructions to:
receive access information related to a Wi-Fi network that the user terminal is accessing.

15. The household appliance of claim 11, wherein, to receive the network access information used to access the network from the user terminal, the at least one processor is further configured to execute the one or more instructions to:
receive a result of determining that the user terminal is accessing a mobile communication network;
request access information related to a local network in which the user terminal is located based on a location of the user terminal; and
receive the access information related to the local network.

16. The household appliance of claim 11, wherein, to receive the network access information to access the network from the user terminal through the established UWB communication channel, the at least one processor is further configured to execute the one or more instructions to:
receive, from the user terminal, user account identification information for a server connection.

17. The household appliance of claim 11, wherein, to receive the network access information to access the network from the user terminal through the established UWB communication channel, the at least one processor is further configured to execute the one or more instructions to:
receive attribute information of the household appliance from the user terminal.

18. The household appliance of claim 17, wherein the attribute information of the household appliance comprises:
at least one of location information, time information, or language information of the household appliance previously set by a user through the user terminal.

19. The household appliance of claim 11, wherein, to receive the network access information used to access the network from the user terminal through the established UWB communication channel, the at least one processor is further configured to execute the one or more instructions to:
receive, from the user terminal, setting information or history information of a same type of a household appliance previously used by a user.

20. A computer-readable recording medium having recorded thereon a program for executing, on a computer, the method of claim 1.
